(19) United States
(12) Patent Application Publication
(10) Pub. No.: US 2024/0272060 A1
(43) Pub. Date: Aug. 15, 2024

(54) METHOD AND APPARATUS FOR PARTICLE DETECTION

(71) Applicant: Regents of the University of Minnesota, Minneapolis, MN (US)

(72) Inventors: Yan Ye, Saratoga, CA (US); David You-Hong Pui, Medina, MN (US)

(21) Appl. No.: 18/568,167

(22) PCT Filed: Jun. 8, 2022
(86) PCT No.: PCT/US22/72824

§ 371 Date: Dec. 7, 2023

Related U.S. Application Data
(60) Provisional application No. 63/208,217, filed on Jun. 8, 2021.
(60) Provisional application No. 63/280,471, filed on Nov. 17, 2021.
(60) Provisional application No. 63/285,485, filed on Dec. 3, 2021.
(60) Provisional application No. 63/337,993, filed on May 3, 2022.
(60) Provisional application No. 63/340,137, filed on May 10, 2022.

(51) Int. Cl. G01N 15/075; G01N 15/00; G01N 15/01

(52) U.S. Cl. CPC G01N 15/075; G01N 15/01; G01N 2015/0038; G01N 2015/0046

(57) ABSTRACT

An apparatus for detecting an analyte particle includes a sample cell configured to be loaded with a sample comprising at least one analyte particle suspended in a suspension medium; an optical source configured to irradiate the sample cell with an optical input signal, and wherein the optical input signal is selected to produce a first light signal from the analyte particle in the sample and a second light signal from atoms or molecules in the suspension medium of the sample; an afocal optical train configured to transmit the first light signal and the second light signal from the sample cell to an image sensor, wherein the first light signal forms an analyte image on tire image sensor, and the second light signal forms a background image on the image sensor.

This application is a PCT application claiming priority to U.S. Provisional Patent Application No. 63/208,217, filed Jun. 8, 2021, entitled “METHOD AND DEVICE FOR DETECTION OF NANOPARTICLES”; U.S, Provisional Patent Application No. 63/280,471, filed Nov. 17, 2021, entitled “METHOD AND DEVICES FOR DETECTION OF SUSPENDED NANOPARTICLES”; U.S. Provisional Patent Application No. 63/285,485, filed Dec. 3, 2021, entitled “METHOD AND DEVICE FOR DETECTION OF SUSPENDED NANO-PARTICLES”; U.S. Provisional Patent Application No. 63/337,993, filed May 3, 2022, entitled “METHOD AND DEVICE FOR DETECTION OF BIOAEROSOLS”; U.S. Provisional Patent Application No. 63/340,137, filed May 10, 2022, entitled “SMART COMPACT BIO-AEROSOL SENSOR”, the entire contents of which is incorporated herein by reference.

### BACKGROUND

Light scattering has been used to detect suspended particles in gaseous and liquid media. To detect particles smaller than the wavelength of the light source, the technique is limited to a small optical focus. Referring to FIG. 1, a particle detection system 10 configured to detect a particle 2 suspended in a suspension medium includes a first lens system 12 that focuses incident light on the particle 2. Light scattered from the particle 2 is then collected by a second lens system 14, which focuses the scattered light for detection by a detector 16. The apparatus of FIG. 1 is derived from the development of ultramicroscopes in the early twentieth century, which is a dark field approach with condenser arid objective lenses to observe or detect a particle in the optical focus. This approach continues to be the basic mechanism of many advanced optical microscopes and laser particle counters used today.

Light scattering by a medium without any suspended particles can only be observed under certain conditions. Researchers in the early 20^{th} century pointed out that fluctuations in density near the critical region would lead to fluctuations in the refractive index of the medium and attributed the observed phenomenon, called critical opalescence, to density fluctuations. Due to random thermal motion, even if a medium is far away from its critical state, density fluctuations in the medium should still exist. However, the fluctuation could be so small that the light scattering by the medium under normal light exposure may not be perceivable. Even using a focused sunlight beam, light scattering by the medium is still not visible under normal conditions. Historically, light scattering is only observed when fine particles are added into the pure medium or a colloidal solution, as described by the Tyndall effect.

Using a laser, it is easier to observe the light scattering by a pure medium such as water or air, and light scattering by a pure water has been used to study physical properties such as light scattering depolarization and anisotropy.

The detection of suspended nanoparticles, which have a detectable dimension (for example, a diameter) between about 1 nm and about 100 nm, remains a challenge, especially if the nanoparticles are housed in containers where the optical focusing settings are not suitable. Improved nanoparticle detection is currently needed for various purposes, such as, for example, checking the cleanliness of unopened bottled drinking water, checking the particulate contaminants directly in semiconductor fabrication or other sensitive equipment, or checking the stability of vaccines in sealed bottles for verification of their expiration date. To overcome the limitations of existing optical instruments and directly detect suspended nanoparticles, an alternative mechanism is needed to magnify the particles that does not rely on optical lenses.

Detecting particles suspended in the air using optical detection techniques has its own challenges compared to detecting particles suspended in liquids such as in water, Particles in a suspending media can be detected by measuring fluctuations in the intensity of light scattered from moving particles, as in dynamic light scattering (DLS) measurement, When particles move randomly in Brownian motion (motion caused by diffusion only), the diffusivity of suspended particles can be deduced from the autocorrelation function describing the fluctuation signals. For particles suspended in a liquid, it is easy to maintain the motion of particles as Brownian motion, especially when the liquid is confined in a small container or in a stationary droplet. DLS measurements have been widely used; as an ISO standard; to measure the size distribution of particles suspended in liquids, from a few nanometers to about 1 micron. Nanoparticles suspended in a liquid can even be observed under an immersion optical microscope because they can effectively remain in a small optic focus space. For particles suspended in the air, the detection is still challenging. It is not practical to confine air samples in small spaces or small containers or to control the motion of the airborne particles so that the motion is caused only by their diffusion. Since airborne nanoparticles are more mobile and more prone to uncontrolled non-Brownian motion than nanoparticles suspended in liquids, techniques that can successfully detect nanoparticles in liquids, such as DLS or advanced optic microscopes, are rarely used for detecting or analyzing airborne nanoparticles.

Particles suspended in the air can be detected by measuring the temporal or spatial average intensity of light scattered from the particles, as a static light scattering (SLS) measurement. Unlike DLS measurements, which require sufficiently fast samplings, SLS measurements use wide-angle or slow samplings to smooth out the fluctuation in light intensity caused by wave phase differences. SLS measurements are simpler than DLS measurements. However, SLS measurements are limited by the detectable light scattering intensity, which is inversely proportional to the sixth power of the particle diameter.

Currently, advanced laser particle counters provided by the world's leading manufacturers have a lower size detection limit of about 100 nm for airborne particles if no growth mechanism is employed to increase the particle size. The particle size growth mechanism increases the complexity of the detection system and limits its applications. An optical detection method that provides nanoparticle detection capability without relying on dynamic light scattering detection or particle growth mechanisms is in high demand, especially for applications hindered by the complexity and compatibility of existing techniques.

### SUMMARY

To improve existing instruments and directly detect suspended particles including, for example, nanoparticles with a largest dimension of about 1 nm to about 100 nm, an alternative mechanism is needed to visually enlarge the particles, rather than just relying on optical lenses. In one example, the present disclosure describes a method and apparatus to detect nanoparticles suspended in a gaseous or liquid suspension medium under conditions in which the light scattering by the atoms or molecules of the suspension medium is intensified to he clearly visible. In the method of the present disclosure, light scattering by the suspended particles is enhanced, and under this condition, a particle image detection approach can be used for detection of particles suspended in a suspension medium.

In one example, when an analyte particle in a sample in a suspension medium is irradiated with an optical input signal, the particle changes the electrical field of the optical input signal with moving charges of the particles to generate light of the same wavelength as the input signal, which is referred to herein as light scattering. A first light scattering signal is obtained from the analyte particle, and a second light scattering signal is obtained from the atoms or molecules of the suspension medium. In some examples, each of the first light scattering signal and the second light scattering signal have the same wavelength as the optical input signal. The first light scattering signal and the second light scattering signal can be detected by a detector to provide analytical data about the analyte particle, with the first light scattering signal representing an image of the analyte particle and the second light scattering signal representing a background image.

In another example, when the analyte particle is irradiated with an optical input signal having sufficient energy, the optical input signal can induce the analyte particle or the atoms and molecules of the suspension medium to emit, in addition to light scattering signals having the same wavelength as the optical input signal, a light of a different wavelength than the wavelength of the optical input signal, which is referred to herein as fluorescence. The wavelength of the fluorescent light signal emitted by the excited analyte particle and the atoms or molecules of the suspension medium is determined by the chemical composition of the analyte particle, and may be detected by a detector. In some examples, in addition to the fluorescent light signal, a first light scattering signal from the analyte particle and a second light scattering signal from the atoms or molecules of the suspension medium may also be detected by the detector to provide additional analytical data about the analyte particle.

In one aspect, the present disclosure is directed to an apparatus for detecting an analyte particle. The apparatus includes a sample cell configured to be loaded with a sample comprising at least one analyte particle suspended in a suspension medium; an optical source configured to irradiate the sample cell with an optical input signal, and wherein the optical input signal is selected to produce a first light signal from the analyte particle in the sample and a second light signal from atoms or molecules in the suspension medium of the sample; an afocal optical train configured to transmit the first light signal and the second light signal from the sample cell to an image sensor, wherein the first light signal forms an analyte image on the image sensor, and the second light signal forms a background image on the image sensor.

In another aspect, the present disclosure is directed to a method, including: loading into a sample cell a sample including at least one analyte particle suspended in a suspension medium; irradiating the sample with an optical input signal emitted by a light source; producing, with the optical input signal; a first light signal from the analyte particle in the sample and a second light signal from atoms or molecules in the suspension medium of the sample; transmitting the first light signal and the second light signal through an afocal optical train to an image sensor, wherein the second light signal forms a background image on the image sensor, and the first light scattering signal forms an analyte image on the image sensor.

In another aspect, the present disclosure is directed to a detector for analyzing a sample comprising an analyte particle suspended in a suspension medium. The detector includes a particle viewing module with a particle viewing chamber configured to retain the sample; an image sensing module connected to the particle viewing module, wherein the image sensing module includes an afocal first lens system interfaced with the particle viewing chamber and an image sensing array configured to receive an optical input from the afocal first lens system; a laser module including at least one laser diode that emits a laser beam with a wavelength detectable by the image sensing array, and a second lens system configured to adjust a shape of the laser beam, wherein the laser beam irradiates the particle viewing chamber to produce a first light signal from the analyte particle in the sample, and a second light signal from atoms or molecules in the suspension medium in the sample; and wherein the first light signal and the second light signal are transmitted through the afocal first lens system to form, on the image sensing array, a background image derived from the second light scattering signal, and an image of the analyte particle derived from first light scattering signal.

In another aspect, the present disclosure is directed to a detection system for analyzing a sample with an analyte particle suspended in a liquid medium. The detection system includes an image sensing module including an afocal first lens system and an image sensing array configured to receive an optical input from the afocal first lens system; a laser module including at least one laser diode that emits a laser beam with a wavelength detectable by the image sensing array, and a second lens system configured to adjust a shape of the laser beam, a container containing the sample, wherein a least a portion of a wall of the container is transparent at the wavelength of the laser beam; wherein the laser beam irradiates the sample in the container to produce a first light signal from the analyte particle in the sample and a second light signal from atoms or molecules in the liquid medium in the sample; and wherein the first light signal and the second light signal are transmitted through the afocal first lens system to form a background image on the image sensing array derived from the second light signal, and an analyte particle image on the image sensing array derived from first light signal.

In another aspect, the present disclosure is directed to a method for analyzing a sample comprising an analyte particle suspended in a liquid medium. The method includes placing a container containing the sample in an analyte detection system including: an image sensing module including an afocal first lens system and an image sensing array configured to receive an optical input from the afocal first lens system; and a laser module including at least one laser diode that emits a laser beam with a wavelength detectable by the image sensing array and transmissible through a wall of the container, and a second lens system configured to adjust a shape of the laser beam; irradiating the sample in the container with the laser to produce a first light signal from the analyte particle in the sample and a second light signal from atoms or molecules in the liquid medium in the sample; and transmitting the first light signal and the second light signal through the afocal first lens system to form a background image on the image sensing array derived from the second light signal, and an analyte image on the image sensing array derived from first light signal.

In another aspect, the present disclosure is directed to a detection system for analysis of a sample comprising a biological analyte particle suspended in air. The detection system includes an image sensing module with an afocal first lens system and a color image sensing array configured to receive an optical input from the afocal first lens system, wherein the color sensing array includes red, blue and green color sensing pixels; an optical module including at least one light emitting diode (LED) or a laser that emits an optical signal with a wavelength of less than about 405 nm, and a second lens system configured to adjust a shape of a beam emitted by the LED; an air permeable sample container containing the sample; and wherein the beam emitted by the LED or laser irradiates the sample to induce a fluorescent light signal from the biological analyte particle; and wherein the fluorescent light signal is transmitted through the afocal first lens system to form an analyte particle image on the image sensing array.

In another aspect, the present disclosure is directed to a method for detecting a biological analyte particle in an air sample. The method includes: passing the sample through a sample module; irradiating the sample in the sample module with an optical signal from at least one light emitting diode (LED) or laser, wherein the optical signal has a wavelength of less than about 405 nm, and wherein the optical signal induces a fluorescent light signal from the biological analyte particle; processing the fluorescent light signal with a color image sensing module, wherein and the fluorescent light signal forms an image on the image sensing array; and analyzing the image to detect a fluorescent signature of a selected biological analyte particle in the sample.

In another aspect, the present disclosure is directed to a bioaerosol detector, including: an air permeable dark space configured to sample ambient air to detect a biological analyte particle suspended therein; an optical module including at least one light emitting diode (LED) or laser that emits an optical signal having a wavelength of less than about 405 nm, wherein the optical signal irradiates the sample in the dark space; an image sensing module including an image sensing array configured to receive an optical input from the dark space; wherein the image sensing module comprises a color image sensing module; wherein the optical signal induces a fluorescent light signal from the biological analyte particle in the sample, and wherein fluorescent light signal forms a biological analyte particle image on the image sensing array.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a schematic diagram of a particle detection system of the prior art that utilizes light scattered from a particle.

FIG. 2A is a schematic diagram illustrating an overhead view of a particle detection system of the present disclosure.

FIG. 2B is a schematic diagram illustrating a side view of a particle detection system of the present disclosure.

FIG. 2C is a schematic illustration of the wave vectors for detecting the light scattered by a particle or molecule at an angle φ to the direction of the oscillating dipole moment or at an angle θ to the propagation direction of a light beam emitted by a light source such as a laser.

FIG. 2D is schematic illustration of the wave vectors and position vectors for a light scattering unit in which a suspended nanoparticle is surrounded by n light scatting medium molecules. The nanoparticle is located at the origin of the coordinate system, \vec{ } is the vector between the nanoparticle and a medium molecule, and \vec{ } is the vector between the nanoparticle and the detector.

FIG. 2E is a schematic comparison of the difference between detection of a light scattering analyte nanoparticle and the detection of light scattering from both an analyte particle and atoms or molecules of a suspension medium according to the present disclosure.

FIG. 3A is a schematic diagram of an embodiment of an optical module suitable for use in a detection apparatus of the present disclosure, and FIG. 3B is a schematic illustration of an example of an interrogating light beam produced by the optical module of FIG. 3A.

FIG. 4 is a schematic cross-sectional diagram of an embodiment of the apparatus of the present disclosure suitable for detecting an analyte particle suspended in a suspension medium.

FIG. 5 is a schematic diagram of an embodiment of the apparatus of the present disclosure suitable for detecting an analyte particle suspended in a suspension medium in a container.

FIG. 6 is a schematic cross-sectional diagram of an embodiment of a system including multiple apparatus of the present disclosure suitable for detecting an analyte particle suspended in a suspension medium, and a particle modification unit between the apparatus,

FIG. 7A is a schematic cross-sectional diagram of an embodiment of the apparatus of the present disclosure suitable for detecting an analyte particle suspended in a suspension medium and inducing fluorescence in the analyte particle,

FIG. 7B is a view taken along line A-A of the apparatus of FIG. 7A

FIG. 7C is a photograph of an example of the apparatus of FIGS. 7A-7B.

FIG. 8 is a flow chart of an embodiment of a method for detecting an analyte nanoparticle according to the present disclosure,

FIG. 9 is a flow chart, of an embodiment of a method according to the present disclosure for detecting an analyte particle in a liquid medium, wherein the analyte particle and the liquid medium are housed in a container.

FIG. 10 is a flow chart of an embodiment of a method according to the present disclosure for inducing fluorescent emission from, and detecting, an analyte particle according to the present disclosure.

FIG. 11A includes light scattering images of pure water using lasers of nominal laser wavelengths at different laser powers as set forth in Example 1 below.

FIG. 11B is a plot of the average intensity per pixel extracted from light scattering images using blue (450 nm) and green (532 nm) lasers at different laser powers according to Example 1.

FIG. 12A is a light scattering image of pure water irradiated simultaneously by blue and red lasers according to Example 1.

FIG. 12B is a light scattering image of room air irradiated simultaneously by blue and red lasers according to Example 1.

FIG. 13A includes plots showing the effect of the angle φ_{l,s} between the polarization of an incident beam and the sensing plane, and the change of the induced light scattering profile with the change of the incident laser beam polarization at several rotation positions.

FIG. 13B is a series of images of light scattering at different angles of φ_{l,s} or φ according to Example 1.

FIG. 13C is a plot of average intensity per sensing pixel extracted from the light scattering images of FIG. 13B.

FIGS. 14A-14C are images of light scattering by 38.2 nm SiO₂ particles suspended in water as outlined in Example 2 below. FIG. 14A is an image of irradiation of pure water with an incident laser power of 3 mW, and water light scattering is barely visible. FIG. 14B shows irradiation of the water with an incident laser power of 15 mW. FIG. 14C is an image taken under the same conditions as FIG. 14B, but the water light scattering is filtered from the image through an image sensor setting.

FIG. 15A is a series of images of light scattering particles of different sizes suspended in light scattering water when the polarization of the incident light rotated at different angle relative the sensing plane of the sensor according to Example 2 when the angle φ_{l,s} is 0°, 45°, and 90°. Note that when φ_{l,s}=90°, the suspended 303 nm PSL particles are visible, and the 38 nm SiO₂ and 5 nm Au particles are not visible.

FIG. 15B is a plot of average intensity extracted from particle light scattering image for 5 nm Au particles and 303 nm PSL particles of Example 2 when the angle φ_{l,s} changes from −10° to 90°.

FIG. 16 is a series of images alight scattering 303 nm PSL particles suspended in light scattering water when using lasers of different wavelengths according to Example 2. The polarization of the incident light was rotated at three different angles relative the sensing plane of the sensor, parallel, 45°, and perpendicular. Note that when the angle is perpendicular φ_{l,s}=90°, the suspended 303 nm PSL particles are still visible when using blue and green lasers, but not visible when using red and infrared lasers.

FIGS. 17A-17B are images showing detection of particles in a bottle of purified water using a green (532 nm) laser according to Example 3 below. During the detection, the bottled water was still sealed by its manufacturer. FIG. 17A shows an image in which the laser had a polarization angle φ_{l,s}=0°, and suspended particles were observed on the light scattering image of water. FIG. 17B is an image in which the polarization angle φ_{l,s}=90°, and most of the suspended particles are not visible. Therefore, the particles in the bottle were assumed to be Rayleigh scattering particles, and they were nanoparticles much smaller than the laser wavelength.

FIGS. 18A-18B are particle detection images performed one week after opening and drinking the bottle of purified water imaged in FIGS. 17A-17B and discussed in Example 3, FIG. 18A is an image using a green laser with the polarization angle φ_{l,s}=0°, and many particles were observed. FIG. 18B is an image using the green laser with the polarization angle φ_{l,s}=90°, and many particles are still visible. Therefore, the particles were assumed not to be Rayleigh scattering particles, and were much larger than the laser wavelength,

FIG. 19 is a photograph of an example of a nanoparticle detector according to the present disclosure as used in Example 4. The nanoparticle detector is made of anodized aluminum parts, and is configured to detect particles flowing through or being trapped in the device. The detector can be assembled or dissembled into several modules.

FIG. 20 is a series of images showing the testing results using the particle detector shown in FIG. 19 and according to Example 4. The particles used in the test were monodisperse soot particles from 70 nm down to 30 nm. Using the particle detector, the soot particles were clearly visible at 70 am, visible at 50 nm, barely visible at 40 nm, and not visible at 30 nm.

FIG. 21 is a photograph of an embodiment of the particle detector of the present disclosure as shown schematically in FIG. 5, and configured to detect analyte particles in a closed container, such as a bottle of drinking water, according to Example 5.

FIG. 22A is an image of particles in a sealed water bottle obtained with the particle detector of FIG. 21 and according to Example 5. FIG. 22B is an image of pure diesel fuel in a sealed container taken with the detector of FIG. 21, FIG. 22C is an image showing dust particles and water droplets mixed in diesel fuel as taken with the detector of FIG. 21.

FIG. 23A is an image of 70 nm NaCl particles detected with the detector of FIG. 19 and according to Example 6 using a green laser with an output wavelength of 532 nm and a power of about 100 mW. FIG. 23B shows an image of 60 nm NaCl particles detected with the setup of FIG. 23A, while FIG. 23C shows an image of 50 nm particles, and FIG. 23D is a background image.

FIGS. 24A-D are images showing the detection of NaCl particles using a blue laser of wavelength of 405 mn according to Example 6, and the laser had a power of about 100 mW. FIG. 24A shows the detection of 60 nm particles, FIG. 24B and FIG. 24D show 50 nm particles, FIG. 24C shows 40 nm particles.

FIGS. 25A-F show the results of detecting soot particles using a blue laser according to FIG. 6. FIG. 25A shows 70 nm soot particles at a concentration of 1.7×10⁵ particles/cc, FIG. 25B shows 60 nm soot particles at a concentration of 1.3×10⁵ particles/cc, FIG. 25C shows 50 nm soot particles at a concentration of 8.8×10⁴ particles/cc, FIG. 25D shows 40 nm soot particles at a concentration of 4.6×10⁴ particles/cc, FIG. 25E shows 30 nm soot particles at a concentration of 1.5×10⁴ particles/cc, and FIG. 25F shows 70 nm soot particles at a concentration of 1.5×10⁴ particles/cc. No particles were detected in FIG. 25E, with more particles being detected as the particle size increased from 40 nm to 70 nm.

FIG. 26 is a photograph of an embodiment of a particle detector according to the present disclosure that can be used for detecting analyte particles in a closed container (a schematic of the device is shown in FIG. 5).

FIGS. 27A-D are images of liquids imaged using the device of FIG. 26 according to Example 7. FIG. 27A shows an image of distilled water, while FIG. 27B shows an image of pure diesel fuel. FIG. 27C shows an image of 1% water in diesel fuel, and FIG. 27D shows an image of 1% water in diesel fuel after settling.

FIGS. 28A-D are images of liquids imaged using the device of FIG. 26 according to Example 7. FIG. 28A shows an image of pure diesel fuel, while FIG. 28B shows an image of diesel fuel and water. FIG. 28C shows an image of diesel fuel and dust, while FIG. 28D shows an image of diesel fuel, dust and water.

FIGS. 29A-D show particle recognition using an image process algorithm for 70 nm NaCl particles imaged according to Example 7. FIG. 29A shows an image of the particles, and FIG. 29B shows an area selected to do the image processing. FIG. 29C showed an image with a low recognition ratio, and FIG. 29D showed an image with a high recognition ratio. The particles recognized were highlighted, and the particle concentration was calculated based on the observation volume. FIGS. 29E-F are plots showing particle concentration in each time increment of 0.03 sec.

FIGS. 30A-F show an imaging process for particle recognition for soot particles with known particle concentrations according to Example 7. FIGS. 30A-C show images and plots displaying particle concentration over time increments of 0.03 sec for 70 nm soot particles at a concentration of 1.7×10⁵ particles per cc, and FIGS. 30D-F show images and plots displaying particle concentration over time increments of 0.03 sec for 50 nm soot particles at a concentration of8.8×10⁴ particles per cc.

FIG. 31A shows images of light scattering and fluorescence from riboflavin particles suspended in air using the bioaerosol detector shown in FIG. 7C above having a blue laser with an output wavelength of 405 nm and according to Example 8. An image of the induced fluorescence from the riboflavin particles is shown in FIG. 31B.

FIG. 32A shows induced fluorescence of a bioaerosol obtained with the detector of FIG. 7C above and according to Example 8, and FIG. 32B is an image of all types of aerosols in a sample, indicating that light scattering the sample was dominant.

FIGS. 33A-D shows images obtained according to Example 8 using the detector of FIG. 7C above with a UV LED with an output wavelength of 365 nm selected to induce fluorescence in airborne biological particles. FIG. 33A is an image showing particles of NaCl were not visible on the detector due to lack of fluorescence, while the image of FIG. 33B shows that nicotinamide (NADH) particles fluoresced to produce an image with light blue particles. The image of FIG. 33C shows that a flavin compound (riboflavin) produced yellow particle images, and FIG. 33D shows that a mixture of flavin and NADH particles produced an image with both yellow and blue particles.

FIG. 34 also shows an image of a mixture of flavin and nicotinamide particles under the conditions of Example 8, which showed light green particles.

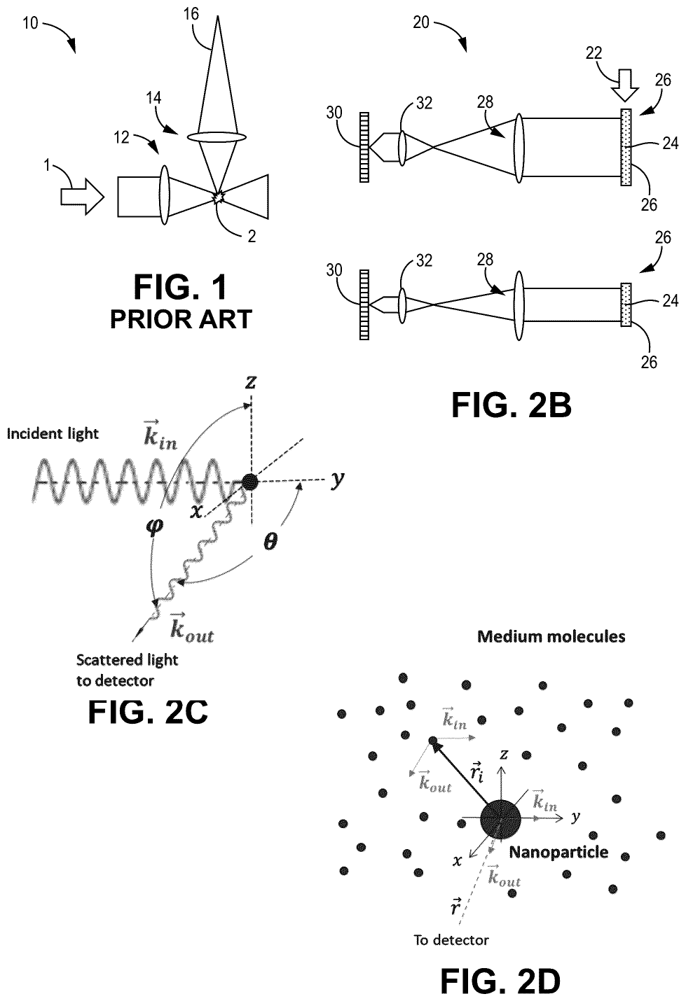

Like symbols in the drawings indicate like elements.

### DETAILED DESCRIPTION

In general, the apparatus and method of the present disclosure detect analyte particles suspended in a suspension medium by detecting: (1) an image of light scattered by the analyte particles, an image of light scattered by the atoms or molecules of the suspension medium; or (2) in addition to and including (1), an image of fluorescent light emitted by the analyte particles. The apparatus and method of the present disclosure make possible the detection of a wide variety of analyte particles suspended in suspension media, including, but not limited to, nanoparticles that are much smaller than a wavelength of incident light, or having a largest detectable dimension of about 40 nm to about 100 nm.

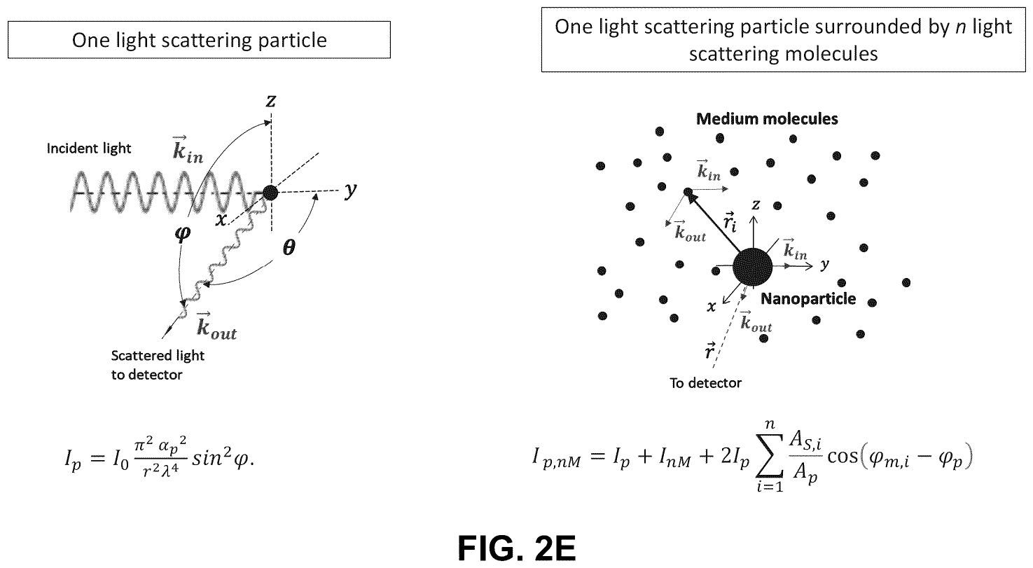

A schematic optical diagram of an embodiment of the method and apparatus of the present disclosure is shown in FIGS. 2A-2B. In FIGS. 2A-2B, the apparatus 20 includes a light source 22 such as, for example, a laser or a light emitting diode (LED), which illuminates with an optical input signal 25 a sample cell 26 loaded with analyte particles 24 suspended in a liquid or gaseous suspension medium 26. The irradiation by the optical source 22 produces a first light signal derived from the analyte particles 24, and a second light signal derived from the atoms or molecules of the suspension medium 26. In the example of FIGS. 2A-213, the first light signal is a light scattering signal, but in some examples discussed below, depending on the energy of the optical signal from the light source 22 and the composition of the analyte particle, the first light signal or the second light signal, or both, may include a fluorescent light signal in addition to, or instead of, a light scattering signal.

An afocal optical train 28 transmits the first light signal and the second light signal to an image sensor 30, which may optionally include optics 32 to further condition the optical signals. The first light signal forms an analyte particle image on the image sensor 30, and the second light signal may optionally be used to form a background image on the image sensor 30. In some examples, the image sensor 30 further includes an image analysis module (not shown in FIGS. 2A-2B) which includes a processor that may be configured to perform a wide variety of analytical analyses on the images obtained by the image sensor 30 including, but not limited to, display or analysis of analyte particles having a dimension with a predetermined size range, display or analysis of analyte particles having a predetermined brightness to provide a particle concentration measurement, or analysis of images of individual selected analyte particles.

The observation of light scattering by a medium without any suspended particles can only be observed under certain conditions of the medium, such as critical opalescence due to strong fluctuation in the density or refractive index of the medium near the critical state. When a medium is far away from its critical state, density fluctuations in the medium are so small that even if a focused solar light beam is used, the light scattering by the medium still cannot be noticed. Historically, light scattering is observed when fine particles are added into the pure medium or in a colloidal solution, as described by the Tyndall effect.

Lasers have made possible the observation of light scattering by a pure medium for particle detection arid analysis. When light shines on nanoparticles suspended in a medium, the charges in the nanoparticles and the medium molecules move in sync with the incoming electric field of incident light wave, resulting in a collection of induced oscillating dipoles with the same frequency and orientation as the incident electric field. Each induced oscillating dipole emits electromagnetic radiation in all directions. The intensity of the emitted radiation depends on the direction of the light scattering as described by Rayleigh scattering. From the standpoint of an individual nanoparticle or a medium molecule, the wave vectors of the incident light and the scattered light to a detector are depicted in FIG. 2C. As shown in FIG. 2C. light is scattered by an analyte particle or an atom or a molecule of a suspension medium at an angle φ to the direction of the oscillating dipole moment, or at an angle θ to the direction of the propagation of the incident light emitted by a light source such as a laser. Typically, the distance between nanoparticles suspended in a medium is much larger than the incident light wavelength. It is reasonable to simulate the whole light scattering as it comes from many small scattering units, and each scattering unit has one nanoparticle of polarizability αₚ surrounded with n medium molecules of polarizability αₘ, as illustrated schematically in FIG. 2D.

FIG. 2E is adopted from Ye, et al., Detection of Nanoparticles Suspended in a Light Scattering Medium, Scientific Reports (2021) 11(1), pages 1-12, and Ye, et al., Detection of Airborne Nanoparticles through Enhanced Light Scattering Images, Sensors 2022, 22, 2038, each of which are incorporated herein by reference in their entirety. The left hand diagram of FIG. 2E, which is substantially the same as the diagram of FIG. 2C, shows a simple case where only the light scattered from nanoparticle is significant. The particle is much smaller than that the incident light wavelength. When a laser light beam interacts with the particle, the charges in the particle will synchronize with the change of electromagnetic field of the light wave, resulting in an oscillating dipole. The oscillating dipole emits an electromagnetic wave at the same frequency as the incident light, called the scattering light. The intensity of the wave or the scattering light sensed by a detector at an angle θ, the angle between the incident light and the direction of the detection, can be expressed in the equation below the left hand diagram in FIG. 2E, called the Rayleigh scattering equation. For a non-polarized incident light, the intensity is only a function of the angle θ, the angle between the light propagation and the detection. There are clearly a forward and a backward scattering from the particle. For a polarized incident light, the intensity is only a function of the angle phi (φ), the angle between the wave oscillating plane and the detection direction.

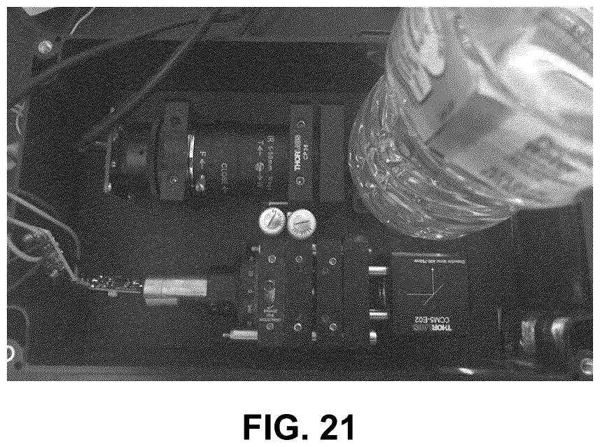

In the diagram on the right side of FIG. 2E, which is substantially the same as the diagram of FIG. 21), light scattered from nanoparticle and molecules surrounding the particle are all significant. When a laser light impacts the nanoparticle and molecules, the electrical charges in the nanoparticle and molecules will synchronize with the electric field of the light wave, resulting in a collection of oscillating dipoles as the scattered light from the nanoparticle and molecules.

In the detection direction, the intensity of the scattered light detected by a detector can he expressed as the equation below the sketch on the right hand side of FIG. 2E. Because the phenomenon can be described mathematically using linear partial differential equations, the waves from the particle and molecules can be superimposed, including interference between the waves. There are three terms in the equation, the first one is due to the light scattered from the nanoparticle, the second due to the light scattered from molecules, and the third is due to the inference between the light scatted from the nanoparticle and from the molecules. The third term can be positive or negative, or constructive or destructive, depending on phase difference or relative motions between the particle and molecules.

To make the intensity above a sensing threshold of a detector, when only the light scattered from an analyte particle is significant, we can move the detector very close to the particle, because the intensity shown in the equation is inversely proportional to the 4th power of the distance between the detector and the particle. Thus, the analyte particle must be observed very closely. On the other hand, when light scattering from the molecules surrounding the nanoparticle are significant, so that the intensity the light scattering shown in the equation is above the sensing threshold of a detector, the nanoparticle detection will rely on how small a light intensity difference detectable by a detector. In addition, in sonic examples, if the optical input signal can produce a constructive interference, the constructive interference can potentially make the analyte particle appear bigger or brighter.

As suggested by the mathematical equations shown in FIG. 2E, instead of observing the analyte particle very closely by focusing the particle in a very small spot as in a conventional approach, the detector apparatus of the present enclosure enhances the light scattering from molecules surrounding the analyte particle, making the light scattering from the analyte particle and molecules above the sensing threshold of a detector. In this way, it is possible to detect analyte particles, nanoparticles, and mixtures and combinations thereof, in a large space with a simple optical system.

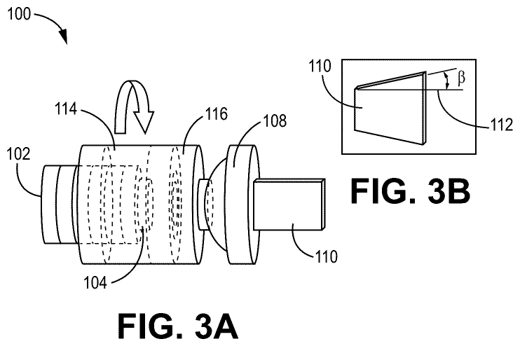

Referring now to FIG. 3A, an optical module 100 for detecting analyte particles suspended in a suspension medium includes at least one light source 102 such as, for example, a laser, a LED, or a combination thereof, that emits an optical input signal 104. In some examples, which are not intended to be limiting, the beam of the optical input signal 104 can be collimated, or can have a conical profile. The beam 104, which has a round profile, enters an optical train 106 that includes a Powell lens 108. The Powell lens 108 alters the round beam 104 and creates a substantially fiat beam 110 with a thin rectangular shape. In some examples, the flat beam 110 has a width of less than about 0.5 mm.

As shown in FIG. 313, the flat or sheet beam 110 can have an angle β relative to a direction of beam propagation 112 that ranges from about 0° to about 75°, or from about 0° to about 45°, or about 5° to about 30°, or about 10° to about 20°, with all angular measurements being ±1°.

The wavelength of the optical input signal beam 104 emitted by the light source 102 can vary widely depending on the types of analyte particles to be detected, and should be matched with an image sensor (not shown in FIG. 3A, shown in more detail below) to provide optimum quantum efficiency and excite more sensing pixels in the image sensor array. For example, in a color image sensor having red, green and blue (RGB) color sensing pixels, the wavelength of the optical input signal can be selected to correspond the green color sensing pixel having the highest quantum efficiency compared to the other color sensing pixels. In some examples, the light source 102 is a laser with an output wavelength of 532 nm for matching with a color image sensor, or an output of 450 nm for matching with a monochromatic image sensor. In another example, the light source 102 can be a LED with an output of less than about 405 nm, or less than about 365 nm, that induces a fluorescent light signal in an analyte particle to be detected.

In some examples, the output power of the light source 102 should exceed a power in which a Tyndall effect is visible for a purified water. In some examples, the output power of the light source 102 is typically higher than 10 mW for visible light, and greater than 50 mW for an IR laser (780 nm and above).

In some examples, the optical module 100 can optionally include a rotating mount 114 including a linear or circular polarizer 116. The polarizer 116 can be rotated with the beam 104 to keep incident power constant during the rotation. The rotation of the polarizer 116 changes to the incident laser polarization relative to a sensing plane of an image sensor, and in some examples the rotation speed of the mount 114 can be up to about 10° per second.

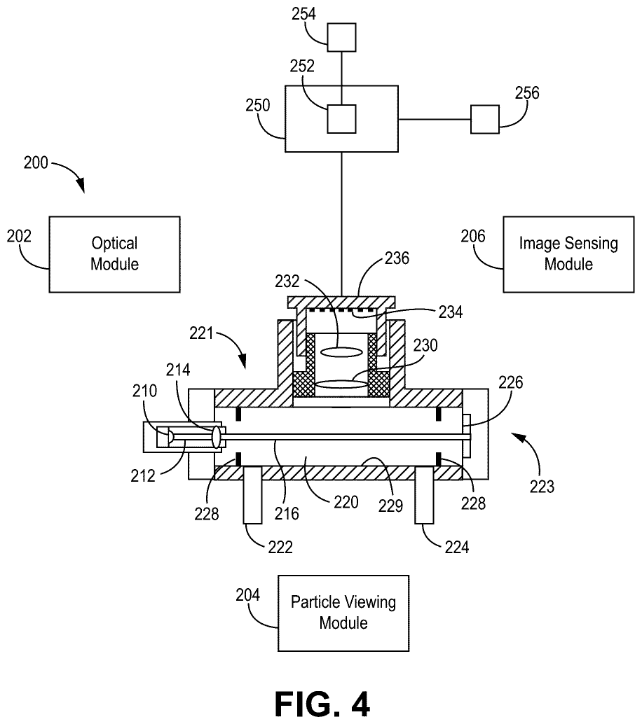

Referring now to FIG. 4, an apparatus 200 for detecting an analyte particle suspended in a suspension medium includes an optical module 202, a particle viewing module 204, and an image sensing module 206.

The optical module 202 includes a light source 210 such as, for example, one or more laser diodes, LEDs, and mixtures and combinations thereof As discussed above, the light source 210 is selected to produce an optical input signal beam 212 with an output wavelength detectable by a detector in the image sensing module 206. The optical module 202 further includes an optical system 214 that can adjust selected characteristics of the beam 212 such as, for example, shape and the polarization. For example, the optical system 214 can include one or more linear or circular polarizers, and the polarizers may be rotated using a rotatable mount as shown in FIG. 3A. The rotatable linear polarizer can keep the polarization of an output beam 216 at a desired angle with respect to a plane of an image sensor in the image sensing module 206. The beam 212 can be collimated or can have a conical profile, and in some examples the optical system 214 can include a Powell lens to narrow the beam 212 with or without an expansion of the propagation direction at a desired angle to provide the output beam 216 with a flat, sheet-like profile as shown in FIG. 3B.

In some examples, the light source 210 is a laser with an output wavelength of 532 nm for matching with a color image sensor, or an output of 450 nm for matching with a monochromatic image sensor. In another example, the light source 210 can be a LED or laser with an output of less than about 405 nm, or less than about 365 nm, that induces fluorescence emissions in an analyte particle to be detected in the particle viewing module 204. In some examples, the output of the light source 210 is typically higher than 10 mW for visible light, and greater than 50 mW for an IR laser (780 nm and above).

The particle viewing module 204 includes a particle viewing chamber 220 configured to retain analyte particles suspended in a liquid or a gaseous suspension medium. In some examples, the particle viewing chamber 220 include an inlet 222 and an outlet 224 to provide a flow of the suspension medium and entrained analyte particles through the particle viewing chamber 220 or to trap the suspension medium in the viewing chamber 220 In some examples, the light source 210 is positioned at a first end 221 of the viewing chamber 220, and can he reflected from an opposed second end 223 of the viewing chamber 220. In some examples, the second end 223 of the viewing chamber 220 can include a light reflection stop or light trap 226 to limit reflecting light within the viewing chamber 220. In soiree examples, the viewing chamber 220 can include one or more light reflection stops 228 to prevent wide angle reflecting light from interior surfaces 229 of the viewing chamber 220 from interfering with image sensing.

In some examples, which are not intended to be limiting, the viewing chamber 220 can have a volume of about 1 mL to about 1000 mL. In some examples, the viewing chamber 220 can be any container having a wall, at least a portion of which is transparent to the light beam 216 emitted by the optical module 202. Examples of suitable containers, which are intended to be limiting, include sealed containers such as a 500 mL water bottle, or other sealed or sealable containers such as beakers, cups, cuvettes or vials.

The image sensing module 206 includes an afocal second lens system 230. The second lens system 230 has a long focal length, and in some examples the focal length of the second lens system 230 can about 5 mm to about 100 mm. The image sensing module 206 further includes an optical train 232 at an entrance to an image sensor 234 on a mount 236. In some examples, the optical train 232 can include a variable focus or zoom lens with a controllable iris having an entrance pupil between about 5 mm and about 30 mm.

The image sensor 234 can be a monochromatic or color sensing array with a pixel density of about 1.3 MP or greater. In some examples, the image sensor 234 has a sensitivity of greater than about 0.05 lux, or about 0.001 lux, when the exposure time of the sensor is greater than about 50 milliseconds at a full gain. In some examples, the pixels in the array of the image sensor 234 are smaller than about 3 microns (μm)×3 μm, or between about 1.2 nm×1.2 μm and 2.9 μm33 2.9 μm. In various examples, the image sensor 234 has an adjustable exposure, gain, brightness, contrast, and frame rate.

The apparatus 200 further includes a controller 250 configured to process detected signals from the image sensor 234. In various examples, the controller 250 may include an integrated processor 252 as shown in FIG. 4, the processor may be integrated in the image sensor 234, or may be a remote processor functionally connected to the controller 70.

The processor 252 may be any suitable software, firmware, hardware, or combination thereof. The processor 252 may include any one or more microprocessors, controllers, digital signal processors (DSPs), application specific integrated circuits (ASICs), field-programmable gate arrays (FPGAs), or discrete logic circuitry. The functions attributed to the processor 252 may be provided by processing circuitry of a hardware device, e.g., as supported by software and/or firmware.

In some examples, the processor 252 may he coupled to a memory device 254, which may be part of the controller 250 or remote thereto. The memory device 254 may include any volatile or non-volatile media, such as a random-access memory (RAM), read only memory (ROM), non-volatile RAM (NVRAM), electrically erasable programmable ROM (EEPROM), flash memory, and the like. The memory device 254 may be a storage device or other non-transitory medium. For example, the memory device 254 may be used by the processor 252 to, for example, store initialization information from the image sensor 234, or previously detected measurements, and the like, for later retrieval.

In some embodiments, the controller 250 and the processor 252 are coupled to a user interface 256, which may include a display, user input, and output (not shown in FIG. 4). Suitable display devices include, for example, monitor, PDA, mobile phone, tablet computers, and the like. In some examples, user input may include components for interaction with a user, such as a keypad and a display such as a cathode ray tube (CRT) display, a liquid crystal display (LCD) or light emitting diode (LED) display, and the keypad may take the form of an alphanumeric keypad or a reduced set of keys associated with particular functions. In some examples, the displays may include a touch screen display, and a user may interact with user input via the touch screens of the displays. In some examples, the user may also interact with the user input remotely via a networked computing device.

The controller 250 can be configured to control any selected number of functions of the detection apparatus 200 including, but not limited to: (1) selectively displaying or analyzing images detected by the image sensor 234 to eliminate particles within a predetermined range (for example, large particles or small particles); (2) measure particle concentration based on brightness of particular spots, or based on a count of bright spots; (3) analyze images to identify individual particles through contours of a connected pixels in the image sensor 234, or to identify individual particles through tracking the motion of the particles.

In some examples, the controller 250 can be configured to generate control signals obtained from, for example, the image sensor 234, to provide closed loop control of the image analysis process. In some examples, the controller 250 may be adjusted by a variety of manual and automatic means. Automatic means may make use of any number of control algorithms or other strategies to achieve desired conformance to an image processing procedure or protocol of the image sensor 234. For example, standard control schemes as well as adaptive algorithms such as so-called “machine-learning” algorithms may be used. In some examples, controller 250 can optionally utilize information from other sources such as, for example, additional cameras obtaining images from the viewing chamber 220, to determine the control action decided by the algorithms by machine learning schemes.

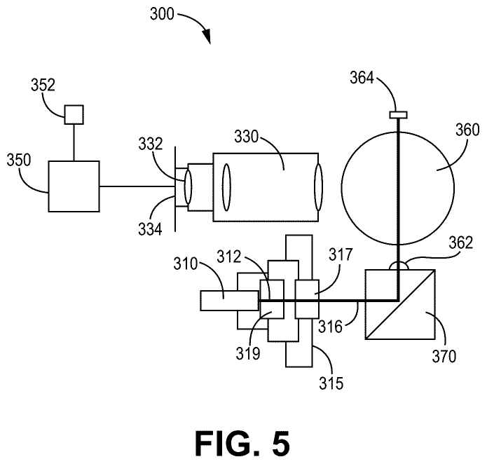

Referring now to FIG. 5, another example of a particle detection apparatus 300 is shown that is configured to detect analyte particles suspended in a suspension medium. The apparatus 300 includes a particle container mount 360 configured to releasably retain a container including a gaseous or liquid suspension medium and analyte particles entrained therein. Any suitable container with a volume of 1 mL to 1000 mL may be mounted on the mount 360, including bottles, cuvettes and the like, and the mount 360 is particularly well suited for mounting of bottles larger 500 mL. As noted above, the container should have a wall, a portion thereof, or a window therein, that is transparent to a wavelength of light emitted by the interrogating light source 310.

As described in detail above in reference to FIGS. 3A and 4, the light source 310 emits an optical input signal beam 312 with an output wavelength detectable by an image sensor 334. An optical system 314 can be used to adjust selected characteristics of the beam 312 such as, for example, shape and the polarization. For example, the optical system 314 can include one or more linear or circular polarizers 317, and in some examples the polarizers 319 may he rotated using a rotatable mount 315 to keep the polarization of an output beam 316 at a desired angle with respect to a plane of the image sensor 334.

As discussed above, the light source 310 may be a laser with an output wavelength of 532 nm for matching with a color image sensor, or an output of 450 nm for matching with a monochromatic image sensor, or may be a LED or an laser with an output of less than about 405 nm, or less than about 365 nm, that produces fluorescence in an analyte particle. The power of the output of the light source 310 is typically higher than 10 mW for visible light, and greater than 50 mW for an IR laser (780 nm and above). In one example, which is not intended to be limiting, the light source 310 is a laser diode with a beam width of about 0.1 mm to about 10 mm, or between about 1 mm and about 5 mm.

The apparatus 300 further includes a beam reflector 370 to change the direction of the beam 316, as well as a Powell lens 362 to narrow the beam 316 with or without an expansion of the propagation direction at a desired angle and provide the output beam 316 with a flat, sheet-like profile (FIG. 3B). The optical path of the beam 316 can further include a beam stopper or intensity sensor 364 configured to detect the beam 316 after the beam 316 traverses a container on the container mount 360.

An afocal second lens system 330 has a long focal length of, for example, about 5 mm to about 100 mm. An image sensor lens 332 at an entrance to the image sensor 334 can include a variable focus or zoom lens with a controllable iris having an entrance pupil between about 5 mm and about 30 nm. In one example the lens system 330 has a field of view between 1 mm×2 mm and 30 mm×60 mm, or about 5 mm×about 10 mm. In one example, the second lens system 330 includes a M12 lens with an angle of view between 5° and 80°, and typically between 20° and 60°, or a c-mount lens of focus length between 5 mm to 200 mm.

The image sensor 334 can be a monochromatic or color sensing array with RGB pixels and a pixel density of about 1.3 MP or greater, or about 2 MP or greater, and has a high sensitivity of greater than about 0.05 lux, or about 0.001 lux. In some examples, the pixels in the image sensor 334 are smaller than about 3 microns (μm)×3 μm, or between about 1.2 μm×1.2 μm and 2.9 μm×2.9 μm. In various examples, the image sensor 334 has an adjustable exposure, gain, brightness, contrast, and frame rate.

The apparatus 300 further includes a controller 350 configured to process detected signals from the image sensor 334. As discussed above, the controller 350 includes an integrated or remote processor 352 that can be configured to control any selected number of functions of the detection apparatus 300 including, but not limited to: (1) selectively displaying or analyzing images detected by the image sensor 234 to eliminate particles within a predetermined range (for example, large particles or small particles); (2) measure particle concentration based on brightness of particular spots, or based on a count of bright spots; (3) analyze images to identify individual particles through contours of a connected pixels in the image sensor 334, or to identify individual particles through tracking the motion of the particles.

In various examples, the system 300 of FIG. 5 can be used to analyze the cleanliness of drinking water in an unopened bottle, check to stability of a vaccine in an unopened bottle, check for water particles or solids in a fuel tank, or check for contaminants in a process chamber or container of clean room equipment used in a process such as semiconductor manufacturing.

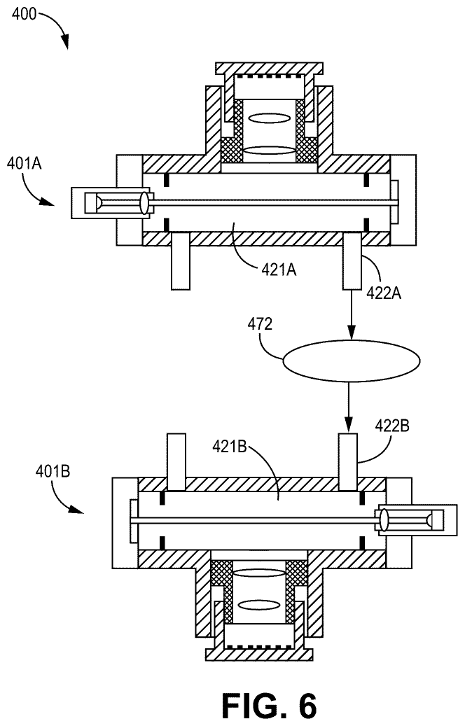

In another example shown in FIG. 6, a particle detection system 400 can include a plurality of the detectors 200, 300 described in FIGS. 4-5 above, and linked to each other to form a network of detectors. In the example of FIG. 6, the particle detection system 400 includes a first particle detector apparatus 401A linked to a second particle detector apparatus 401B, An outlet 424A on the viewing chamber 421A of the first particle detection apparatus 401A is connected to an inlet 422B in one the viewing chamber 421B on the second particle detection apparatus 401B. A particle change unit 472 is between the apparatus 401A, 401B. In some examples, which are not intended to be limiting, the particle change unit 472 may include a filter testing unit for filter efficiency, or a particle size discriminator for measure particle size distribution.

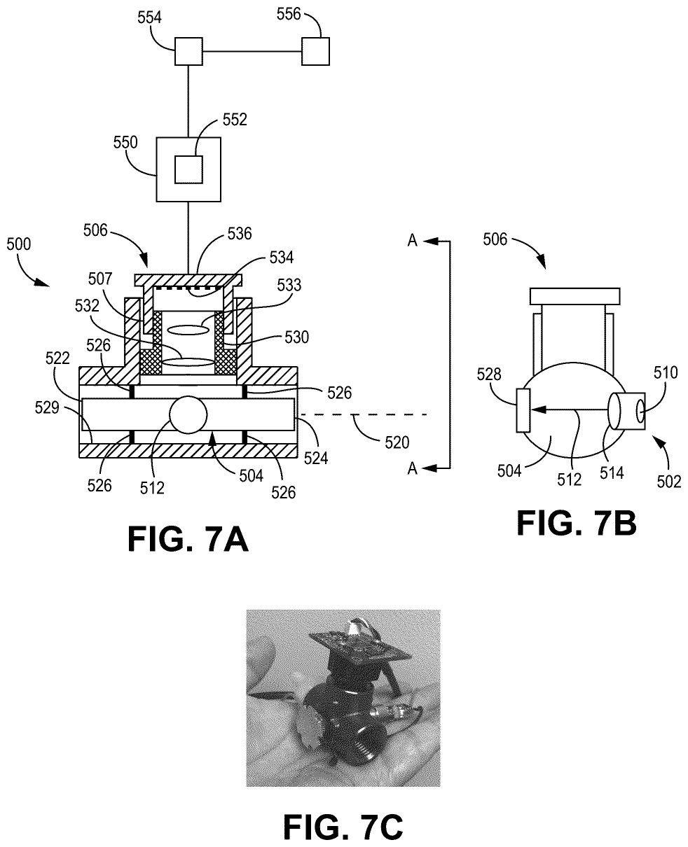

In another example, the particle detection apparatus of the present disclosure may be used to detect airborne biological analyte particles. Referring now to FIGS. 7A-7B, an apparatus 500 for detecting bioaerosols includes an optical module 502, a particle irradiation and viewing dark space 504, and an image sensing module 506.

The optical module 502 includes a light source 510 with an output wavelength selected to induce fluorescence emissions from a selected airborne bioanalyte particle, and to produce an optical input signal beam 512 with an output wavelength detectable by a detector in the image sensing module 506. The optical module 502 further includes an optical system 514 that can adjust selected characteristics of the beam 512 such as, for example, shape and the polarization. For example, the optical system 514 can include one or more linear or circular polarizers, and the polarizers may be rotated using a rotatable mount as shown in FIG. 3A. The rotatable linear polarizer can keep the polarization of an output beam 516 at a desired angle with respect to an image sensor in the image sensing module 506. The beam 512 can he collimated or can have a conical profile. In some examples, the optical system 514 can optionally include a filter 527 that passes UV wavelengths but blocks visible light wavelengths from entering the particle viewing module 504. In some examples, the optical system 514 can optionally include a short focus lens (for example, less than about 4 mm) to focus the beam 516 right under the image sensor lens system 530.

In some examples, the light source 210 is a blue or UV light source such as an LED or laser with an output of less than about 405 nm, or less than about 365 nm, or less than 300 nm, which produces an optical input signal having sufficient energy to induce fluorescence in an analyte particle to be detected in the particle viewing module 504.

The particle viewing space 504 includes an inlet 522, and an outlet 524 to provide airflow through the particle viewing chamber 520 or to trap an air sample in the viewing space 504. In the example of FIGS. 7A-7B, the LED light source 510 is positioned to emit the optical input beam 512 in a direction generally normal to a longitudinal axis 520 of the particle viewing space 504, but many suitable arrangements are possible.

In some examples, the particle viewing space 504 can optionally include one or more light reflection stops 526 or a light trap 528 to limit reflecting light within the viewing space 504. The light reflecting stops 526 can prevent wide angle reflecting light from interior surfaces 529 of the viewing space 504 from interfering with image sensing.

In some examples, which are not intended to be limiting, the viewing space 504 can have a volume of about 1 mL to about 1000 mL.

The image sensing module 506, which in the embodiment of FIGS. 7A-7B includes an optional threaded adjustment mount 507, includes an afocal image sensing lens system 530. In some examples, the lens system 530 includes an optical element 532 having a long focal length of, for example, about 5 mm to about 100 mm. The lens system 530 can further include an optical element 533 at an entrance to an image sensor 534 on a mount 536. In some examples, the optical element 533 can include a variable focus or zoom lens with a controllable iris having an entrance pupil between about 5 mm and about 30 mm.

The image sensor 534 can be a monochromatic or color sensing array with a pixel density of about 1.3 MP or greater, which has a high sensitivity of greater than about 0.05 lux, or about 0.001 lux, and an exposure time of greater than 50 milliseconds at full gain. In some examples, the pixels in the image sensor 534 are smaller than about 3 microns (μm)×3 μm, or between about 1.2 μm×1.2 μm and 2.9 μm×2.9 μm. In various examples, the image sensor 534 has an adjustable exposure, gain, brightness, contrast, and frame rate.

The apparatus 500 further includes a controller 550 configured, to process detected signals from the image sensor 534. The controller 550 may include an integrated processor or remote processor 552.

In some examples, the processor 552 may be coupled to a memory device 554, which may be part of the controller 550 or remote thereto. In some embodiments, the controller 550 and the processor 552 are coupled to a user interface 556.

In the example of FIGS. 7A-B, the controller 550 can be configured to control any selected number of functions of the detection apparatus 500 including, but not limited to: (1) selectively displaying or analyzing images detected by the image sensor 534 to eliminate particles within a predetermined range (for example, large particles or small particles); (2) measure particle concentration based on brightness of particular spots, or based on a count of bright spots; (3) analyze images to identify individual particles through contours of a connected pixels in the image sensor 534, or to identify individual particles through tracking the motion of the particles. In addition, the controller 550 is configured to recognize a predetermined fluorescence color in the particle detection image on the image sensor 534, to count airborne bioanalyte particles with a predetermined color, or to count bioanalyte particles with a predetermined size or shape.

In various examples, the system 500 of FIG. 7 can be used to detect airborne bioanalytes relating to human health such as, for example, tuberculosis, influenza, or COVID-19, and the like, or bioanalytes relating to animal health such as coccidioidomycosis, anthrax, swine flu, and the like. The system 500 can also be used to detect airborne bioanalytes relating to plant health including black stem rust, white pine blister rust and the like. The system 500 can also be used to detect airborne allergens such as pollens from trees, plants, houseplants and weeds, or proteins shed from household pets. In addition, the system 500 can be used to detect airborne biological warfare analytes including bacteria, rickettsia, viruses, protein toxins, neurotoxins produced by microbes, and the like.

In some examples, as shown in FIG. 7C, the system 500 can be incorporated into a small detector having a weight of less than about 50 grams and consuming less than about 5 W of total power. In some examples, the detector is attachable to clothing, or may be mountable on a surface such as a wall, a countertop, and the like. In some examples, the detector includes an alarm configured to provide an audible alert when a selected biological analyte particle is detected, or when a predetermined amount of a selected biological analyte particle is detected. In some examples, the detector can utilize pumpless sampling to move samples through the sampling chamber such as, for example, when a person is in motion, and can be used to provide real time in situ monitoring for airborne biological analytes. In some examples, the detector may further include an optional particle concentrating device.

In some examples, the detectors, which are small, lightweight, and consume very little power, may be incorporated into a network including a plurality of detectors. The detectors in the network may he deployed in different locations, for example, in rows of seats in an airplane cabin, in different rooms of a building, in different buildings, or in different areas of an open environment or a man-made environment, also referred to herein as a built environment, to provide rapid detection of airborne biological analytes.

A photograph of an example of the small detector is shown in FIG. 7C, which can easily fit in a palm of a human hand.

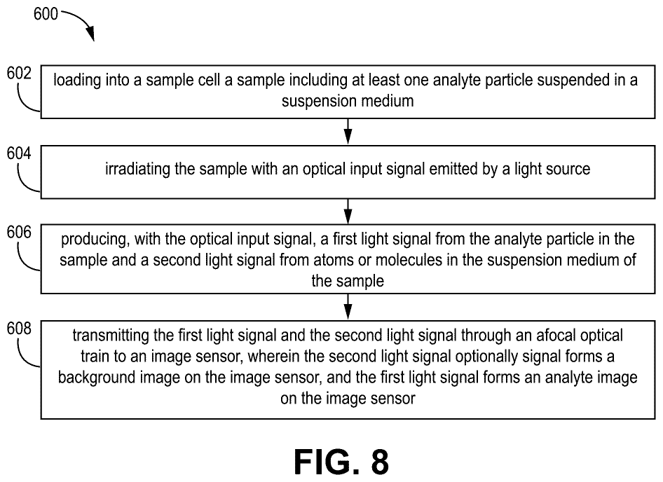

Referring now to FIG. 8, in another example, the present disclosure is directed to a method 600 for detecting an analyte suspended in a suspension medium. The method 600 includes a step 602 of loading into a sample cell a sample including at least one analyte particle suspended in a suspension medium. In step 604, the sample is irradiated with an optical input signal emitted by a light source.

Step 606 includes producing, with the optical input signal, a first light signal from the analyte particle in the sample and a second light signal from atoms or molecules in the suspension medium of the sample. In some examples, each of the first light signal and the second light signal, may be a light scattering signal having the same wavelength as the wavelength of the light source, or a fluorescent light signal induced in the analyte particle by the optical input signal, or a combination thereof

In step 608, the first light signal and the second light signal are transmitted through an afocal optical train to an image sensor, wherein the second light signal optionally forms a background image on the image sensor, and the first light signal forms an analyte image on the image sensor.

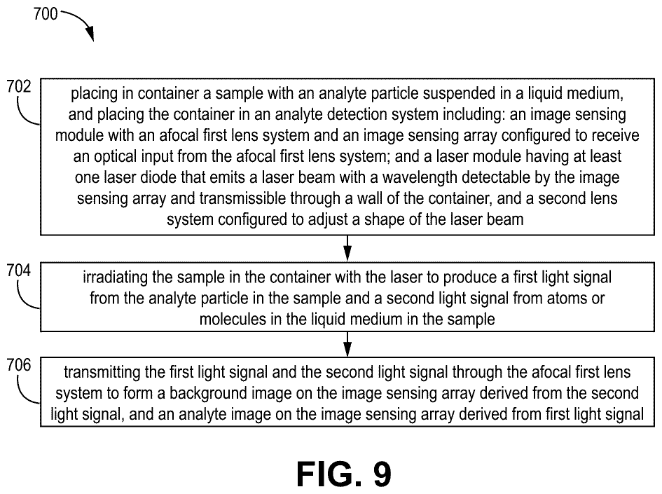

Referring to FIG. 9, in another aspect the present disclosure is directed to a method 700 for analyzing a sample including an analyte particle suspended in a liquid medium, wherein the sample is in a container. In some examples, the container may be sealed.

Step 702 of the method 700 includes placing the container in an analyte detection system including: an image sensing module with an afocal first lens system and an image sensing array configured to receive an optical input from the afocal first lens system; and a laser module having at least one laser diode that emits a laser beam with a wavelength detectable by the image sensing array and transmissible through at least a portion of the wall of the container, and a second lens system configured to adjust a shape of the laser beam.

Step 704 includes irradiating the sample in the container with the laser to produce a first light signal from the analyte particle in the sample and a second light signal from atoms or molecules in the liquid medium in the sample, In some examples, the first and the second light signals may be light scattering signals having the same wavelength as the wavelength of the light source, a fluorescent light signal induced in the analyte particle by the optical input signal, or a combination thereof.

Step 706 includes transmitting the first light signal and the second light signal through the afocal first lens system. In some examples, the second light signal can optionally he used to form a background image on the image sensing array. The first light signal can be used to form an analyte image on the image sensing array. In some examples, the first light signal may be a light scattering signal having the same wavelength as the wavelength of the light source, or may be a fluorescent light signal induced in the analyte particle by the optical input signal.

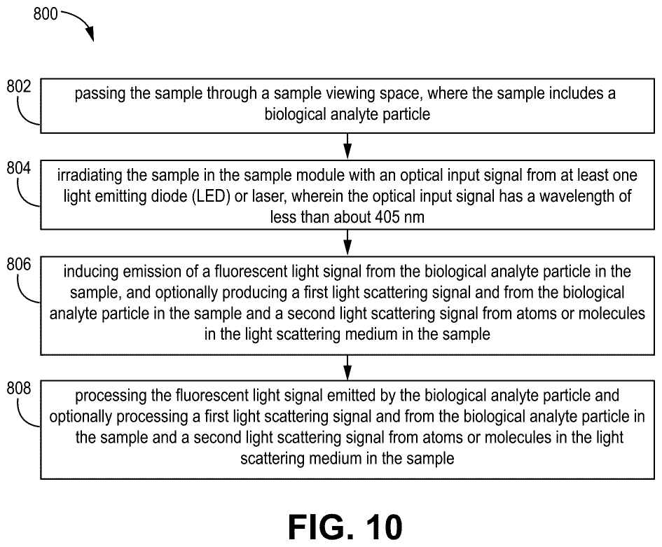

In another aspect shown in FIG. 10, the present disclosure is further directed to a method 800 for detecting a biological analyte particle in a sample with a light scattering medium. Step 802 of the method 800 includes passing the sample through a sample viewing space, and step 804 includes irradiating the sample with an optical input signal from at least one light emitting diode (LED) or laser, wherein the optical input signal has a wavelength of less than about 405 nm.

In step 806, the optical input signal induces emission of a fluorescent light signal from the biological analyte particle in the sample. In some examples, the optical input signal can also optionally produce a first light signal and from the biological analyte particle in the sample and a second light signal from atoms or molecules in the light suspension medium in the sample.

Step 808 includes processing the fluorescent light signal emitted by at least one of the biological analyte particle or the atoms or molecules of the suspension medium, and optionally processing the first and second light scattering signals with an image sensing module including an image sensing array,

Step 810 includes analyzing the fluorescent light signal to detect a fluorescent signature of a selected bioanalyte particle in the sample. In some examples, step 810 optionally includes forming a background image on the image sensing array derived from the second light scattering signal, or forming an analyte image derived from the first light scattering signal on the image sensing array.

The present invention will now he further described with reference to the following non-limiting examples.

### EXAMPLES

### Example 1

### Light Scattering in a Pure Medium

Several experiments were performed to verify that the brightness of the light scattering image perceived by an image sensor obeys the mechanism of Rayleigh scattering. The intensity of the light scattered by a medium should also be proportional to the intensity of incident light. When the incident light intensity or power exceeds a certain level, light scattered by a medium should become high enough so that the image of the light scattering can be distinguished from the dark background with an image sensor. This trend was checked through images of light scattering of pure water using lasers of different nominal wavelength at several different powers.

The water was purified, filled, and sealed into a clean glass bottle in a semiconductor fabrication clean room. The seal of the water bottle remained unopened during the light scattering test to minimize contamination. The diameters of incident laser beams were adjusted to around 1 mm using an adjustable iris. The laser power was adjusted using two wire-gride linear polarizers while keeping the polarization of incident laser beam perpendicular to the earth, or parallel to the imaging plane of the sensor. The exposure as well as other parameters of the image sensor were set at a fixed position.

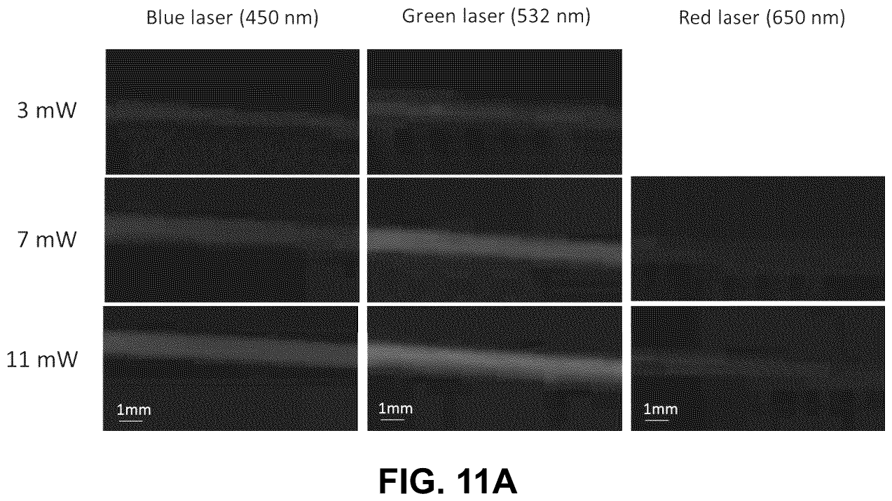

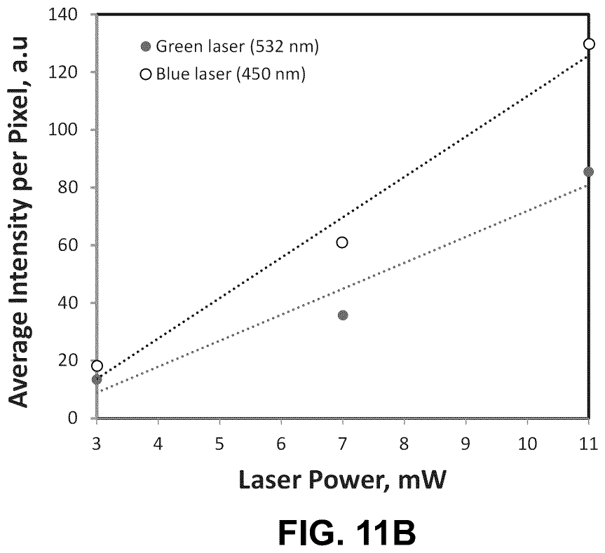

FIG. 11A shows images of light scattering by pure water when blue, green and red lasers with nominal wavelengths of 450 nm, 532 nm, and 650 nm used at different laser powers. Using the blue and red lasers, when the laser power was 3 mW, the light scattering image of water was almost not distinguishable from the dark background, and when the laser power was 11 mW, the light scattering image became clearly visible. Using the red laser, even if the laser power was 11 mW, the light scattering image of water was still difficult to recognize from the dark background. The brightness of the image resulting from the blue laser are about the same as that from the green laser, rather than 1.95 times brighter as calculated based on the inversely proportional to the 4th power of the wavelength, 1/λ⁴, as predicted by theory. While not wishing to be bound by any theory, it is believed that these results occurred because the brightness of light scattering image depends on also the image sensor and the optical system used for the test. The color image sensor usually uses a Bayer color sensing array, in which each blue or red pixel has two green pixels. the image of green light should receive the double light signal for the brightness if the light intensity for each pixel is the same, in addition, the quantum efficiency of blue pixels is typically lower than that of green pixels. Therefore, even though the intensity of light scattered by a medium using a green laser is lower than that using a blue laser, it is possible to make the green light scattering image look the same or brighter than the blue light scattering image.

FIG. 11B shows the average intensity of light scattered by pure water at each sensing pixel when using blue and green lasers. The intensity at each pixel was extracted from the light scattering images and corrected using quantum efficiency. Referring to the data of similar image sensors, the quantum efficiency for the blue light was selected as 70% and the quantum efficiency of the green light was selected as 93% in the plot. The plot shows clearly that the light scattering intensity from the water was proportional to the power of the laser. It shows also that even though the light scattering image using the green laser was brighter that that using the blue laser, the average light scattering intensity per pixel using the blue laser is higher than that using the green laser.

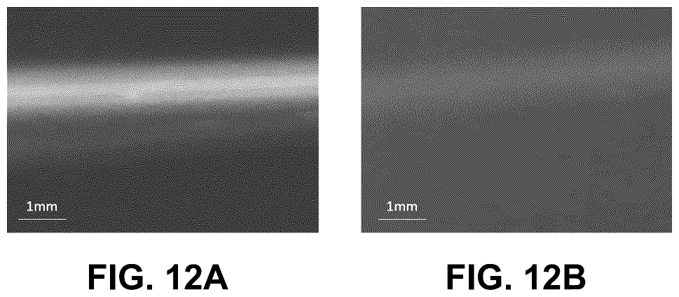

Experiments were also performed to compare the light scattering by pure water and by particle-free air. In the test, each medium was irradiated with both blue and green laser beams at the same time. The power of these two lasers was about 20 mW, and the laser beam diameter was adjusted to about 1 mm. Longer exposure time of the image sensor were used to make the image of scattered from air is more visible. As shown in FIGS. 12A-12B, the light scattering by particle-free room air can be observed, but it was weaker than the light scattering by water. As expected, due to the lower index of refraction and concentration, higher laser power was required to enhance the light scattering image of air. It is also expected that the image of light scattering by the air using the blue laser does not have to be brighter than that using the green laser. According to the experimental observations, it was estimated that a green laser with a power greater than 100 mW may be needed to make the light scattering by air have a brightness similar to that by the water as shown in FIG. 12A. Although the laser power is quite high, it is still within the range of class 3B laser (5-500 mW). Using light scattered by the air to detect nanoparticles suspended in the air still seems feasible.

Another import feature of Rayleigh scattering is that the scattering intensity varies with the angle φ between the direction of oscillating dipole moment and the direction of the scattered light to be observed. When using a polarized light source, intensity of a Rayleigh scattering will change with the change of sin²φ. In the era when only bulky lasers were available, it was common to fix the laser source in a position while rotating a photodetector, or using several photodetectors, around the laser for a light scattering measurement. For the application of detecting nanoparticles in a large container, it becomes impractical to rotate an image sensor around a laser beam. As the laser module becomes more compact than before, it is more convenient to rotate the direction of oscillating dipole moment through rotating the polarization of incident laser beam relative to a fixed image sensor, It is more convenient to express the change of the angle φ with the change of the angle φ_{l,s} between the plane of linear polarization of incident laser and the plane of image sensing of the sensor. The angle φ and the angle φ_{l,s} are complementary, φ+φ_{l,s}=90°.

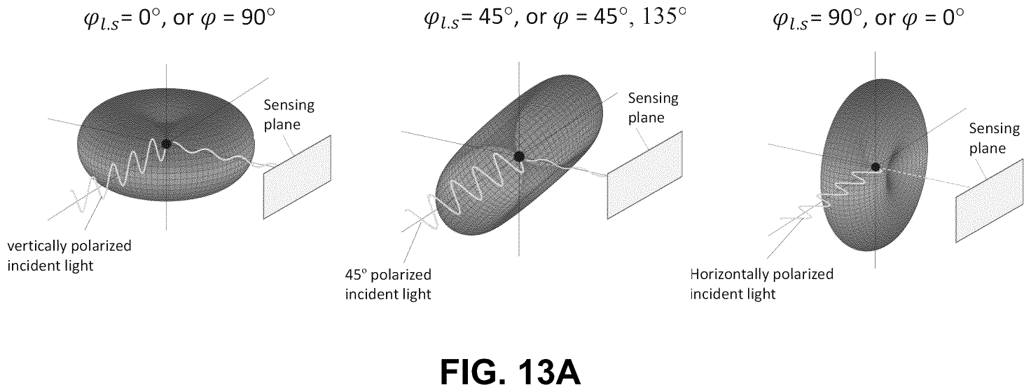

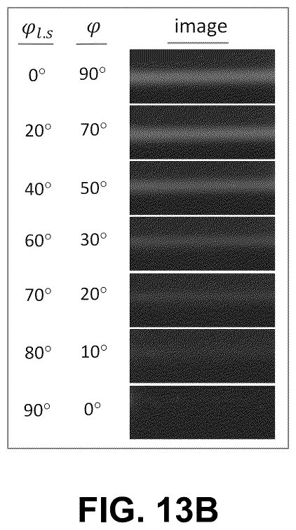

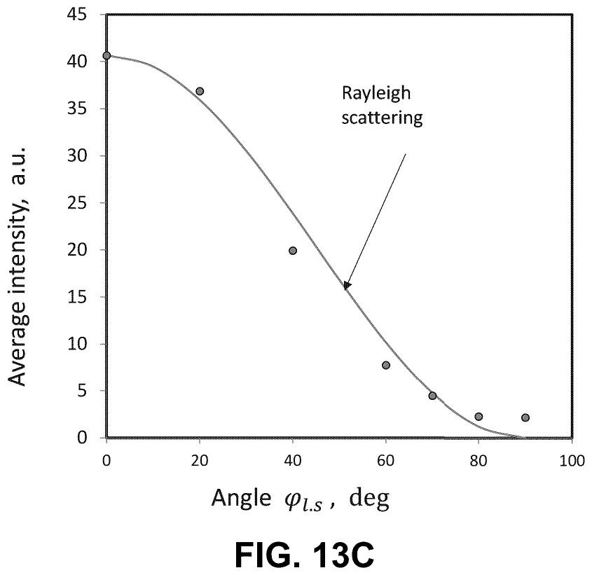

In another experiment, the image sensor faced the laser beam at a fixed scattering angle θ of 90° relative to the laser propagation direction. FIG. 13A shows 3-D curves of light scattering intensity profile when the plane in which incident light wave oscillates are parallel, 45°, and perpendicular with respect to the plane that light scattering is sensed.

FIG. 13B shows images of light scattering by pure water when the angle φ or φ_{l,s} changes. The light scattering image of the beam is the brightest when the two planes are parallel φ_{l,s}=0°, and the images become dimer and dimer as the two planes moves from the parallel position toward a vertical position φ_{l,s}=90°.

FIG. 13C plots the intensities of the scattered light that are measured from light scattering images along the laser beams shown in FIG. 13B. The plot shows that the brightness of the light scattering image of pure water can be expressed with the light intensity at the sensing pixels extracted from the image. A curve using A·sin²φ or A·sin² (90°−φ_{l,s}), where A is selected to match the average intensity value at φ_{l,s}=0, is also plotted in FIG. 13C. The plots show that the brightness of light scattering image changes with the change of incident light polarization, and the trend of the change was consistent with the Rayleigh scattering equations.

It should he noted that the laser power for making the medium light scattering visible presented in the work is only for the optical system used in the test. Although the trend is universal, the specific value may be not. For example, if an old generation imaging sensor is used at the same laser powers as shown in FIG. 11, images of the light scattering are still not clearly distinguishable from the dark background. In addition, particle contaminants in the water could affect the light scattering as will be discussed below. Furthermore, the container material could also affect the laser power for visibility of the light scattered by the medium. Therefore, the experimental results here only show the maturity of creating a light scattering medium environment for particle detection.

### Example 2

### Light Scattering Images of Nanoparticles Suspended in a Light Scattering Medium

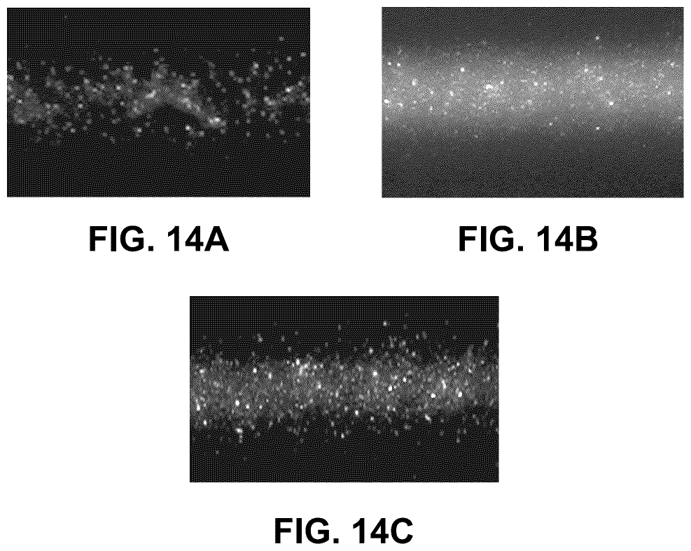

As light scattering of the molecules of the suspension medium is intensified to the extent to be visible using an image sensor, the light scattering of the particle suspended in the medium should be also intensified. FIGS. 14A-B compare light scattering images of 38.2 nm SiO₂ particles under conditions that the light scattering by water is almost invisible and clearly visible. It clearly shows that when the water light scattering is more visible, the particles looks brighter and larger. In fact, light scattered by water presents as a fine shiny background, and light scattered by the particles presents as moving bright dots on the shiny background. By setting the threshold intensity in the image sensor, the water scattering image can be filtered out without changing the nanoparticle light scattering image, as shown in FIG. 14C.

The process is similar to removing the background layer from the superimposed image. When the light scattering by water is hidden from the image, all other light scattering effects remain the same. Therefore, the image still carries the enhancement effect from the light scattering medium to the scattering nanoparticles. The interference between the light scattering by water and the light scattered by the particles may also play a role in making the nanoparticles appear larger and brighter.

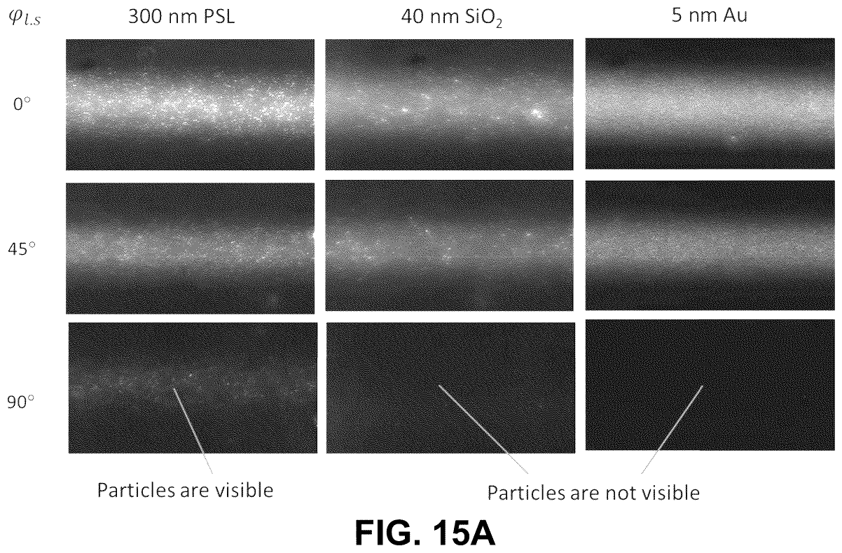

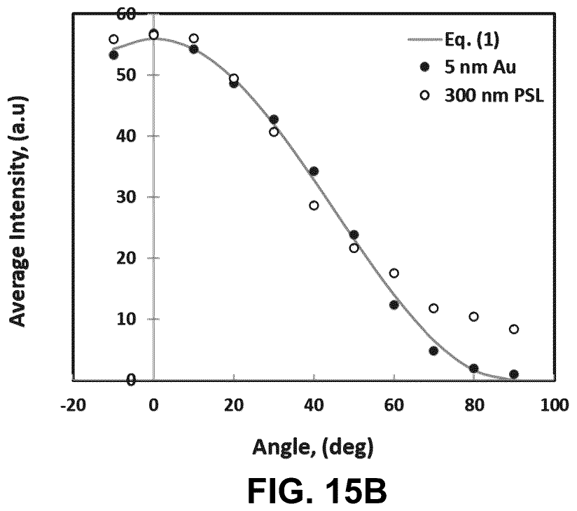

Since the nanoparticles are much smaller than the wavelength of the light source used for the particle detection, the intensity of scattered light should follow Rayleigh scattering. The brightness of light scattered by particles should change when the polarization plane of the incident laser beam rotates against the sensing plane of the sensor. FIG. 15A shows the images of light scattering by 303 mn PSL particles, 38.2 nm SiO₂ particles, and 5 nm gold particles at different angles of φ_{l,s}. In the test, light scattered by water was visible, and the scattering angle θ relative to the laser propagation was fixed at 90°. If the light scattering is a Rayleigh scattering, brightness of particle scattering image should change as a function of sin²φ or sin²(π/2−φ_{l,s}). That is, when φ_{l,s} is set at 90°, or the polarization plane and the sensing plane are perpendicular, light scattered intensity perceived by the sensor should be zero. It was observed in the experiment that, when φ_{l,s} is 90°, suspended 303 mn PSL particles become dimmer but still visible, while 38 nm SiO₂ and 5 nm Au particles are not visible. While not wishing to be bound by any theory, the evidence suggests that this effect occurs because the 303 nm PSL particles are too large compared to the wavelength of the incident laser to he considered as Rayleigh scattering particles at the wavelength. A more detailed measurement of particle light scattering with the change of angle φ_{l,s} were performed using 303 nm PSL particles and 5 nm Au particles, as shown in FIG. 15B. The light intensity was adjusted to make the intensity from bath particles about the same when φ_{l,s}=0°, and the curve of A·sin²φ or A·sin²(90°−φ_{l,s}) is also plotted, where A is selected to make the value match the average intensity at φ_{l,s}=0° in the plot. The result shows that the light scattering by the 5 nm Au follows well with the Rayleigh scattering for all angles, while the light scattering by the 303 nm PSL particles start to deviate from the Rayleigh scattering at the angle φ_{l,s} above 70°. This can be explained that when the particle size is close to the wavelength of the incident laser, light scattered by the particles no longer act as point sources and starts to deviate from Rayleigh scattering. This deviation is manifested in the direction where the emission due to the oscillating dipole moment is weak.

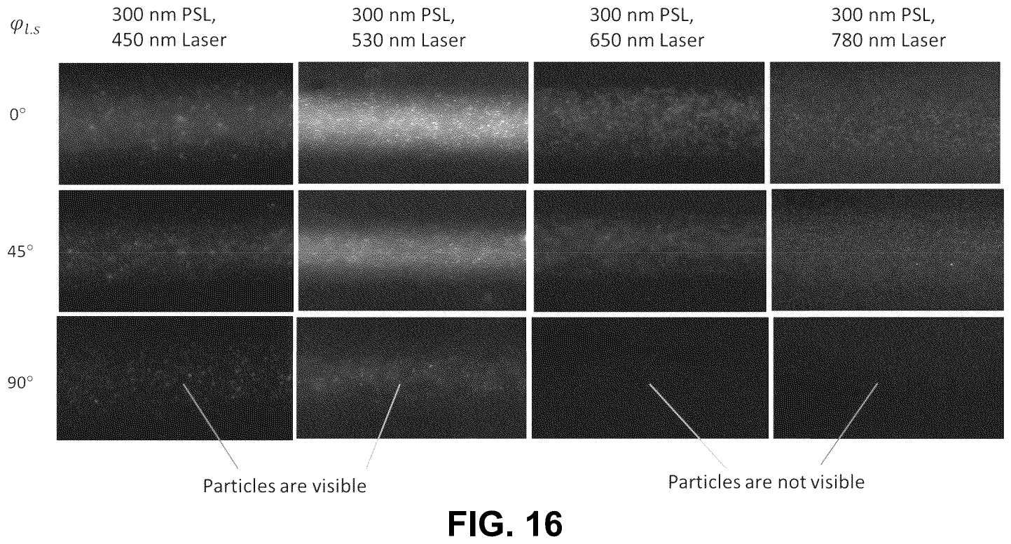

Light scattering by 303 nm PSL particles suspended in water are further tested with lasers of different wavelengths. When the angle φ_{l,s} is 0°, the brightness of light scattering images from these lasers are adjusted to he similar. As shown in FIG. 16, when φ_{l,s} is 90°, the 303 nm PSL particles can he seen using blue (450 nm) and green (532 nm) lasers, but the particles cannot be seen using red (650 nm) and infrared (780 nm) lasers. Since the particle size is fixed, the longer the wavelength make the particles relatively smaller, so the light scattering by the particles are more toward to Rayleigh scattering. It further supports the explanation that when φ_{l,s} is 90°, the visibility of particles is related whether the light scattering of the particles is the Rayleigh scattering or not. Since the visibility of particles is determined by how well the scattering from the particle follows the Rayleigh scattering, the feature can be utilized to distinguish large particles from small nanoparticles.

Particle concentration can be measured through brightness measurement as the concentration correlates with the total light scattering intensity. Under certain conditions, concentration of particles suspended can be directly determined through digital image analysis of a picture of particles. For example, particle count can be determined from a picture of light scattering images using the gaussian-weighted adaptive threshold method available in an open-cv Python package. Using the method, particle count in the picture shown in FIG. 148 above is estimated to be about 880. Theoretically, the particle count can be further converted to actual particle concentration.

Beyond just distinguishing large particles from nanoparticles, it is possible to further measure the size distribution of particles suspended in a light scattering medium. There are several adjustable measurement functions that can be utilized to determine the relationship between particle concentration and particle size distribution. The adjustable measurement functions comprise of tuning the scattering angle relative the dipole moment direction through rotation of incident laser, displaying selectively images of light intensities through image sensor settings, and screening light scattering pattern through an image analysis algorithm. The measurement can also combine with other external mechanisms that can influence particle motion or light scattering. All the adjustable measurement functions are not limited into a small focus space. The apparatus of the present disclosure will open the door for development of new approaches to directly size suspended nanoparticles contained in large containers.

### Example 3

### Detection of Suspended Nanoparticles in a Large Container

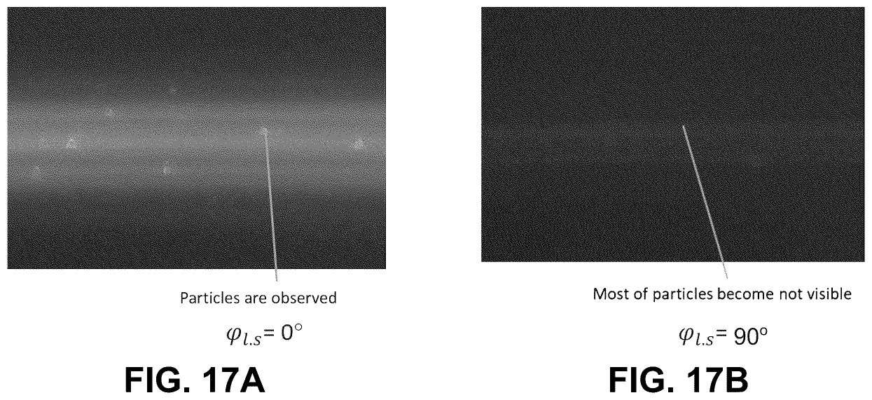

This experiment tested detection of particles in a bottle of purified water. During the test, the bottled water remained sealed as made by its manufacturer. The water was approximately 15 months away from its expiration date indicated on the bottle. When the angle φ_{l,s} between the polarization plane of the incident laser and the sensing plane of the image sensor was 0°, many particles are observed with light scattered by water as a background, as shown in FIG. 17A. Particles can be easily recognized from the light scattering background from water since the particles are moving spots. When the angle 0.5 is rotated to close to 90°, although the laser power remained the same, except for one or two large particles, most of the particles become invisible, as shown in FIG. 17B. Since most of the particles follow well the Rayleigh scattering equation, the particles in the bottle are likely nanoparticles that are much smaller than the wavelength of the laser used for the detection. Based on the ratio of light scattering intensity from the particle and light scattering by water, it is estimated that the particles are between 50 to 100 nm. Based on the observed particle counts, it is estimated that number particle concentration was less than 104 particles per milliliter. The particle detection for the bottled water was repeated several times in a period of several months. No significant change was observed between the detections. Therefore, the particles are likely not from deterioration of the water cleanliness or from the degradation of the bottle material. The particles more likely came from the manufacturing process.

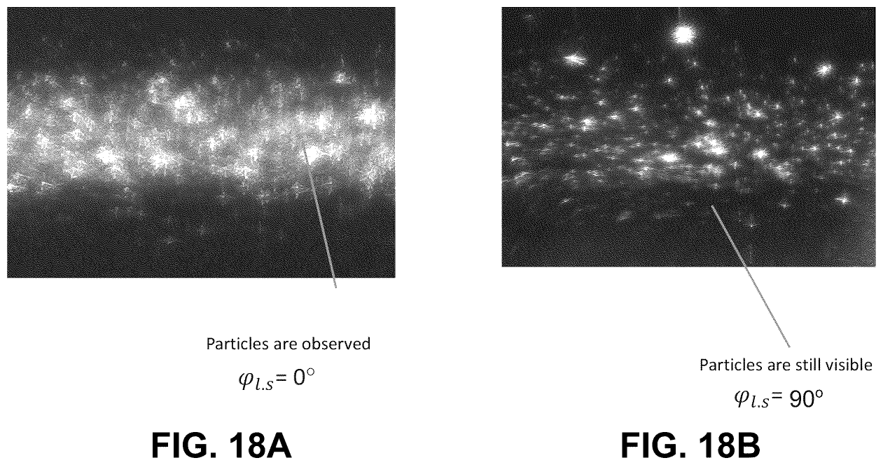

One week after half of the water in the bottle was consumed, particles in the water were checked again. After drinking, the bottle was not tightly capped, and was placed in a warm room. When performing the particle detection at the angle φ_{l,s}=0°, much more particles are observed, as shown in FIG. 18A. When performing the particle detection at the angle φ_{l,s}=90°, there were still a lot of particles are visible, as shown in FIG. 18B. Therefore, many of the particles in the bottle observed at the time were much larger than the wavelength of the incident laser. These particles were likely microorganisms that multiplied and grew during the week of testing, and may be harmful for human body.

Several other bottled waters from different manufactures and different storage conditions were tested, which showed significant differences in terms of particle concentration and particle size. Some of the particles were likely from bottle materials, such as micro-plastics, and some of the particles were likely biological or living organisms. The method was also used to detect particles suspended in DI waters filled in bottles. The results indicate that a lot of particles can be present in DI water, depending on the source of the Dl water, how the DI water is stored, and the cleanliness of the DI water container. Since the apparatus of the present disclosure is not limited to a small volume required for using high numerical aperture lenses, the apparatus can be mounted. or equipped on a robot used in an open space, such as in the ocean.

The above results indicate that intensified light scattering of the suspension medium can be intentionally utilized for detection of particles. As light scattering by the medium is intensified, the light scattering by the particles suspended in the medium also becomes intensified, and constructive interference may also occur between the light scattered by the particles and the light scattered by the medium. When using a pulse detection approach, the benefits of the light scattering medium may be limited, because high light scattering by the medium may result in lower signal to noise ratio or a loss in the dynamic range of the detection. However, when using an image detection approach, this is not an issue, because the image detection approach is more like an interferometer, where the reference and signal are on the same image. The light scattered by the medium thus forms a quasi-static background, while the light scattered by particles are moving objects.

On the other hand, the intensified light scattering of the medium can also be the result of using a high power laser. The use of high-power lasers is an option to improve the detection performance of smaller arid smaller particles. As shown above, the medium light scattering should not be something to be avoid, especially when using the image detection method. Lasers used in the work are in the low power range of a Class 3B laser. Within the same safety category, there is still a lot of room for using higher power lasers for particle detection, which will allow suspended nanoparticles to be seen more clearly.

Several light scattering characteristics can be utilized for sizing suspended nanoparticles. A quick and effective way to distinguish between nanoparticles and large particles is to check whether the light scattering of the particles is Rayleigh scattering. This approach can be realized by examining whether the particles are visible when the polarization plane of incident laser changes from parallel to perpendicular relative to the sensor plane of the sensor. In addition, the difference of light scattering intensity for different size particles can be further utilized for measuring particle size distribution. As the light scattered by the medium becomes strong, the difference in lights scattered from particles of different size also increases. Integrating unique measurement functions provided by the image detection with the light scattering by a suspension medium, it is possible to further develop a new method to calculate and determine the concentration and size distribution of suspended nanoparticles.

The method of the present disclosure utilizes the intensified light scattering of the suspension medium to make the nanoparticles easier to detect by an image sensor. Since this method dose not rely on the optical lenses to focus the light source into a small space, it is more flexible for detection of particles suspended in different conditions. As demonstrated experimentally above, the method can be used to directly detect suspended nanoparticles contained in a large container and distinguish small nanoparticles from large particles.

### Example 4

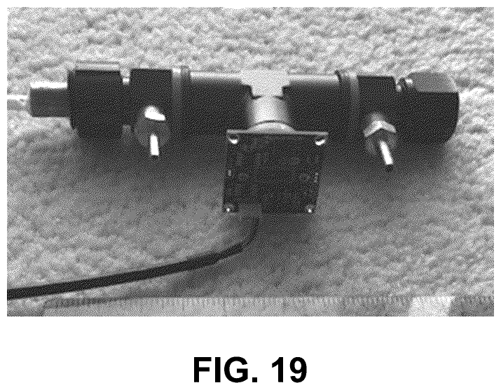

FIG. 19 shows an example of a nanoparticle detector according to the present disclosure. The parts of the detector exposed to the laser were made of black anodized aluminum, but any anodization color may be used. The interfaces between the outside and the inside of the device were sealed with silicone rings or gaskets to achieve vacuum or liquid seal.

The detector used a 2 MP image sensor and a M12 lens unit of 8 mm focus length and a 40° view angle.

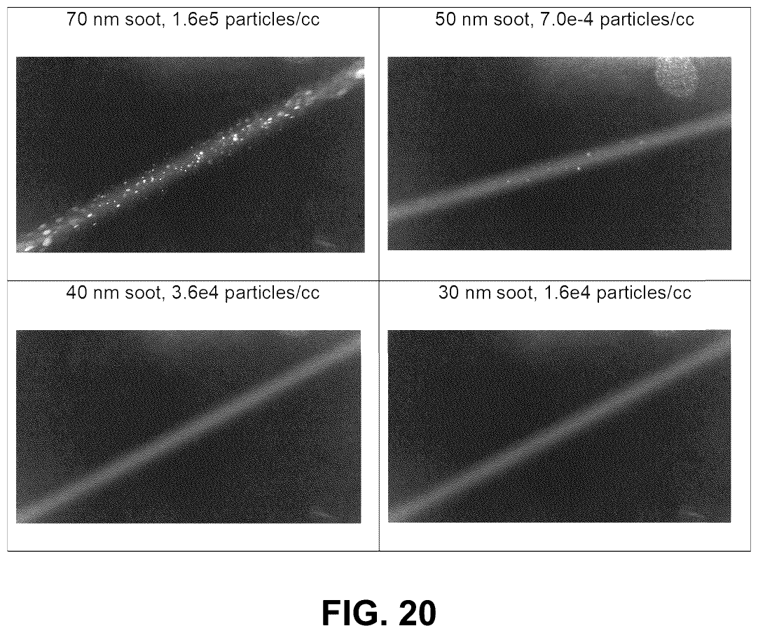

FIG. 20 shows the testing results using the particle detector shown in FIG. 19. The particles used in the test were monodisperse soot particles from 70 nm down to 30 nm. Using the particle detector, the soot particles were clearly visible at 70 nm, visible at 50 nm, barely visible at 40 am, not visible at 30 nm.

### Example 5

FIG. 21 shows the picture of a prototype particle detector suitable for detecting the cleanliness of bottled drinking water, and FIG. 5 above depicts the setup and main components of the particle detector. A laser diode module, an optional rotatable linear polarizer, and fixed linear polarizer were mounted on a rotating station. The rotational linear polarizer can be used to adjust the laser intensity and the fixed linear polarizer keep the polarization of incident laser with a required angle relative to the image sensor. The Powell lens narrows the laser beam with or without an expansion in the propagation direction at an certain angle. The location of the beam reflector and the attached Powell lens can be adjusted to fit the requirement of incident light for different container. The beam stopper can be a circularly polarized polarizer or a beam intensity sensor with a beam attenuator. The lens system can be a telephoto lens or a long working distance lens with adjustable focus. The lens system can have an iris for adjusting the image light brightness or resolution. A digital lens was placed between the telephoto or long working distance lens and the image sensor, or can he attached to the image sensor.

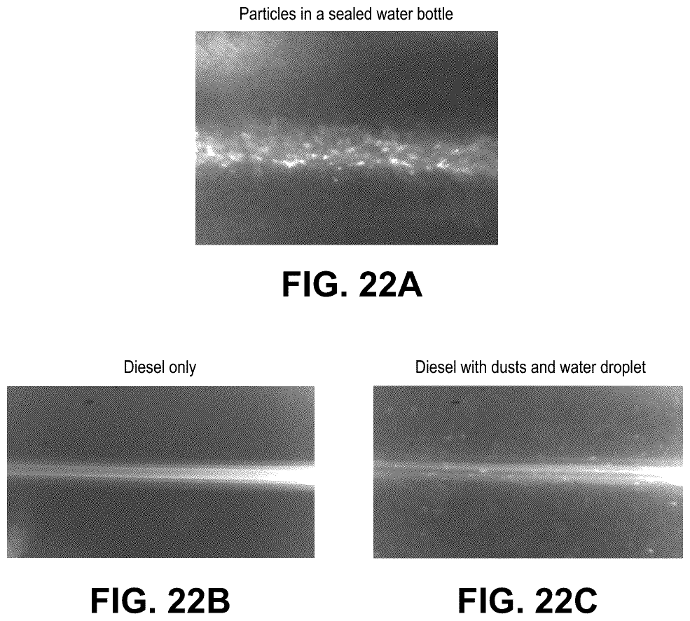

FIG. 22A shows results for detection of particles in a sealed water bottle using the device of FIG. 21, FIG. 22B shows particle detection of pure diesel fuel, and FIG. 22C shows the dust particles and water droplets mixed in diesel fuel.

### Example 6

The small particle detector of FIG. 19 was used to detect nanoparticles. The detector was simple with a laser irradiating a sample from one side of a sample chamber and trapped in the other end, and particles were observed in between with an image sensor. The inlet and outlet of the sensor introduced particles flowing through or trapping inside the particle detector. As shown in FIG. 19, the size of the detector was quite compact, and the cost was quite low.

The particles used were NaCl particles generated with an atomizer, and soot particles generated using a diffusion burner. The mono-disperse distribution of the particles was achieved by passing the particles through a dynamic mechanical analyzer (DMA), and particle concentration was checked with a condensation particle counter (CPC).

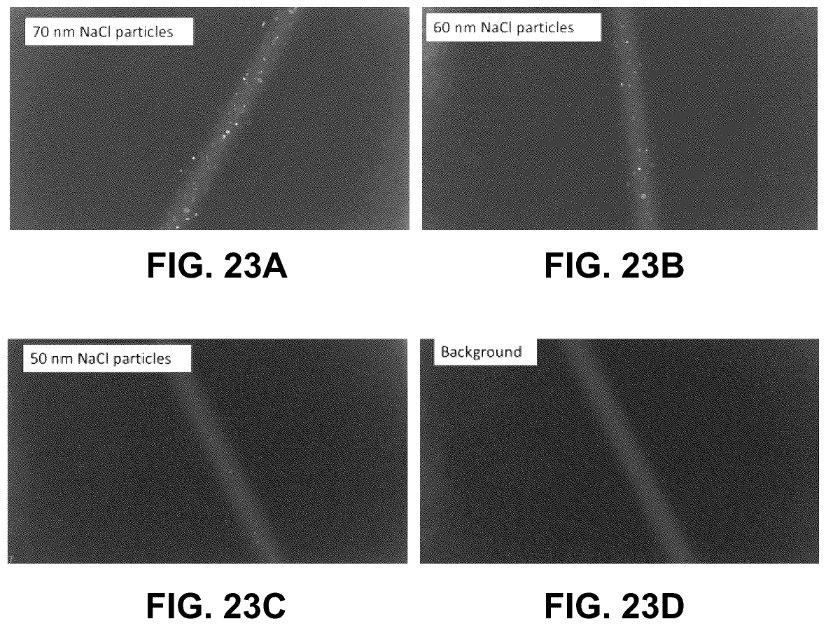

FIGS. 23A-D show particle testing data using the NaCl particles. The laser used was a green laser with an output wavelength of 532 mn, and the power was around 100 mW. FIG. 23D is background, which has no particles, and clearly shows the light scattering from air molecules, but no particles. Overall, the results of FIG. 23 show that the images of the particles become smaller and dimmer as the particles become smaller, comparing between 70 nm (FIG. 23A), 60 nm (FIG. 23B), and 50 nm (FIG. 23C). The 50 nm particles in FIG. 23C can be barely seen, close to a cutoff.

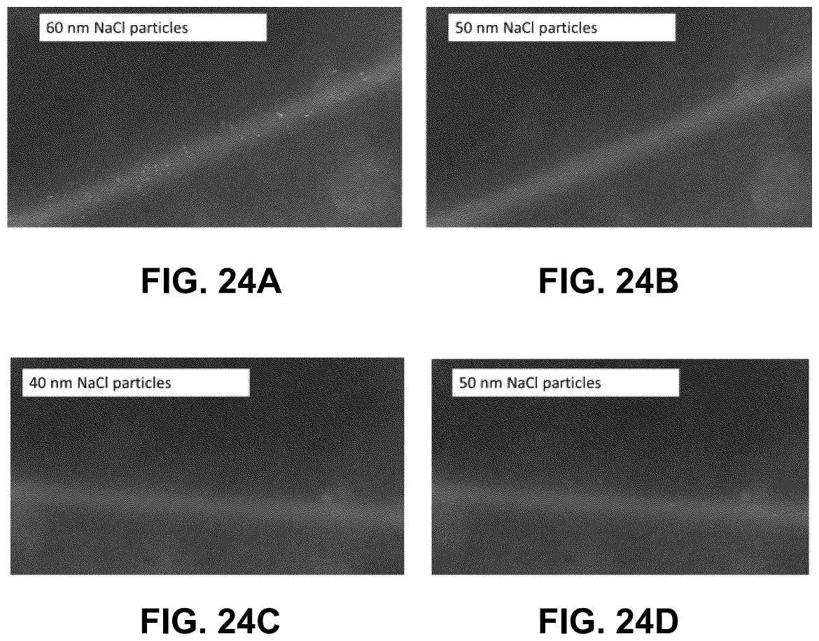

FIGS. 24A-D show the detection of NaCl particles using a blue laser with an output wavelength of 405 nm. The power was also about 100 mW. FIG. 24A shows the detection of 60 nm particles, FIG. 24B and FIG. 24D show the detection of 50 nm particles, FIG. 24C shows the image of 40 nm particles. The results of FIGS. 24B and 24D show that the particle detection results are repeatable. The detected particles appeared more clearly in the image formed by the 405 nm laser.

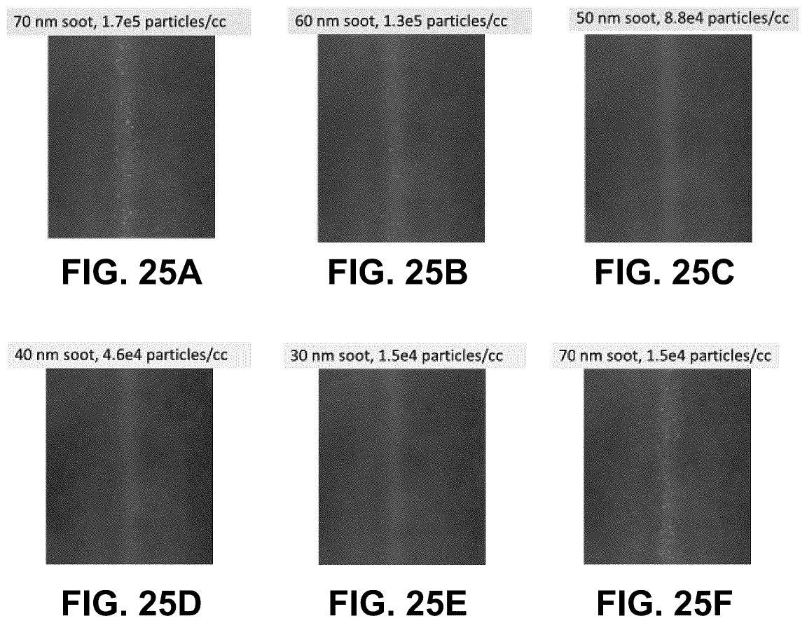

FIGS. 25A-F show the results of detecting soot particles using a blue laser. FIG. 25A shows 70 nm soot particles at a concentration of 1.7×10⁵ particles/cc, FIG. 25B shows 60 nm soot particles at a concentration of 1.3×10⁵ particles/cc, FIG. 25C shows 50 nm soot particles at a concentration of 8.8×10⁴ particles/cc, FIG. 25D shows 40 nm soot particles at a concentration of 4.6×10⁴ particles/cc, FIG. 25E shows 30 nm soot particles at a concentration of 1.5×10⁴ particles/cc, and FIG. 25F shows 70 nm soot particles at a concentration of 1.5×10⁴ particles/cc. No particles were detected in FIG. 25E, with more particles being detected as the particle size increased from 40 nm to 70 nm.

### Example 7

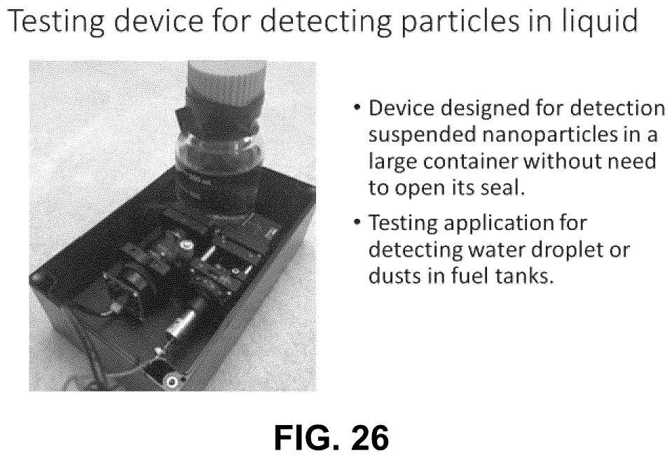

The particle detector apparatus of FIG. 5 above was used to detect particles in a liquid, and a photograph of the device used in this example is shown in FIG. 26.

The detector had a rotating station that made it possible to change the oscillating plane of the laser light wave, Therefore, it could be determined whether the particles were Rayleigh scattering particles or Mie scattering particles, and it could be further evaluated whether the particles were nanoparticles or microparticles. Because the particle detection did not necessarily rely on the small focusing space, it was possible to detect particles in a large space. The dimensions of the particles in the could be evaluated even without opening the seal, which is quite different than the conventional approach which requires pouring the sample into a different container or a sampling tray.

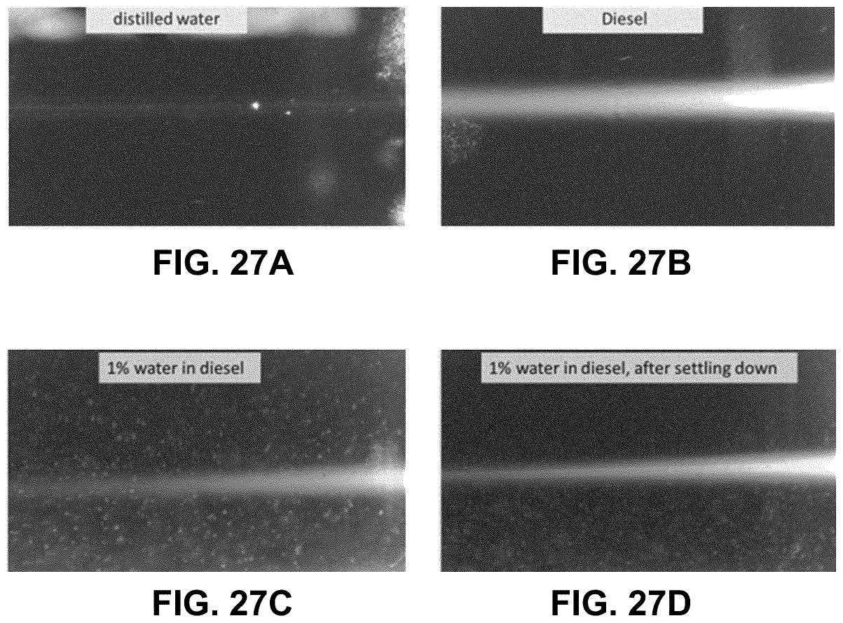

FIGS. 27A-D show the results of detecting particles in liquid, FIG. 27A shows particles in distilled water, most of which were Rayleigh scattering particles, instead of Mie scattering particles, therefore, most of particles were nanoparticles. There were only a few particles determined to he Mie scattering or large particles. FIG. 27B shows detection of particles in diesel fuel, which in this example appeared to be much cleaner than the distilled water of FIG. 27A. FIG. 27C shows particle detection of a diesel fuel sample including about 1% water, and the water particles in the diesel are clearly visible. FIG. 27D shows particle detection of the diesel fuel sample of FIG. 27C, after settling. FIG. 27D clearly shows water particles settling toward the bottom of the container, and the water is the form of particles instead of a water layer. The device of the present disclosure allowed determination of not only the number of the particles, but also allows viewing of the motion of the particles.

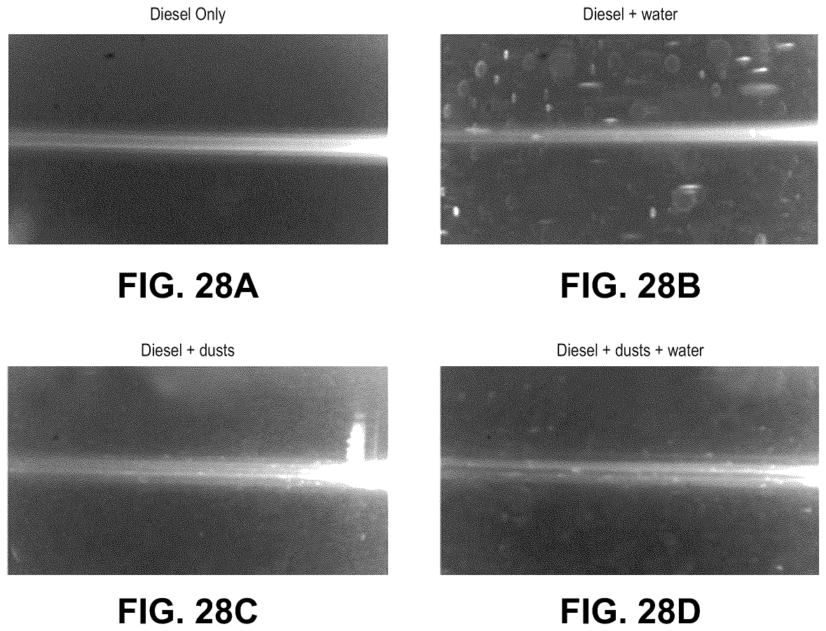

FIG. 28A shows detection of particles in diesel fuel only, while FIG. 28B shows detection results on a sample including a mixture of diesel fuel and water, but no small particles. FIG. 28C shows detection of the dust in diesel fuel, and most of the particles are smaller than the water particles. FIG. 28D shows detection results of water and dust particles in diesel fuel. FIGS. 28A-D show that the particle sizes and motions are different between the different types of particles,

Taking images of particles is only half of the story for particle detection, and in Kale cases, the existence of the particles is an important measurement. While images can be helpful, if there is a need to determine a number of particles, images only may be insufficient.

To determine quantitative particle information, the particles should be counted in the image. With the information of from the laser beam and viewing depth, particles can be observed in a given volume, calculated, and the particle count converted to particle concentrations. The particle count in an image is achieved through image processing. It is more like face recognition, and the algorithms used for the particle count may perform differently, some with high recognition ratio, some have a low recognition ratio

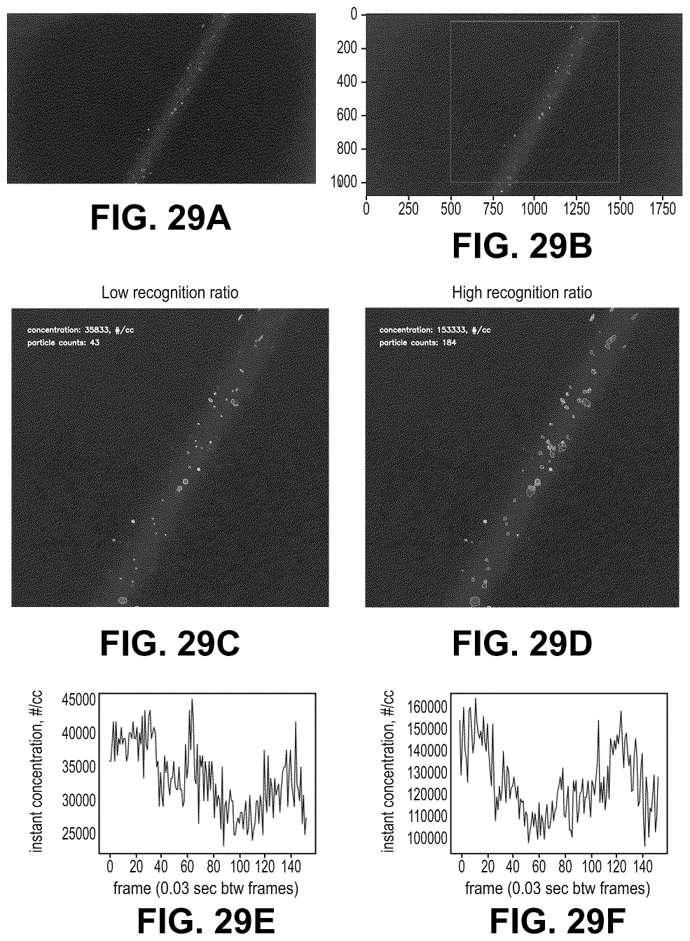

FIGS. 29A-D shows particle recognition using an image process algorithm for 70 nm NaCl particles tested in the laboratory. FIG. 29A shows an image of the particles, and FIG. 29B shows an area selected to do the image processing. Some of particles could be recognized and some were not recognizable, FIG. 29C showed an image with a low recognition ratio, and FIG. 29D showed an image with a high recognition ratio. The particles recognized were highlighted, and the particle concentration was calculated based on the observation volume.

The process was quite rapid, as the refresh rate for the image sensor was 30 frame per second, therefore, we had a total of 150 frames for 5 seconds. The time between each frame was about 0.03 second.

The plots in FIGS. 29E-F shows particle concentration in each time increment of 0.03 sec. A time average concentration can be calculated from the plots, and it is also possible to set up an alarm to trigger other actions when the particle concentration exceed as predetermined value.

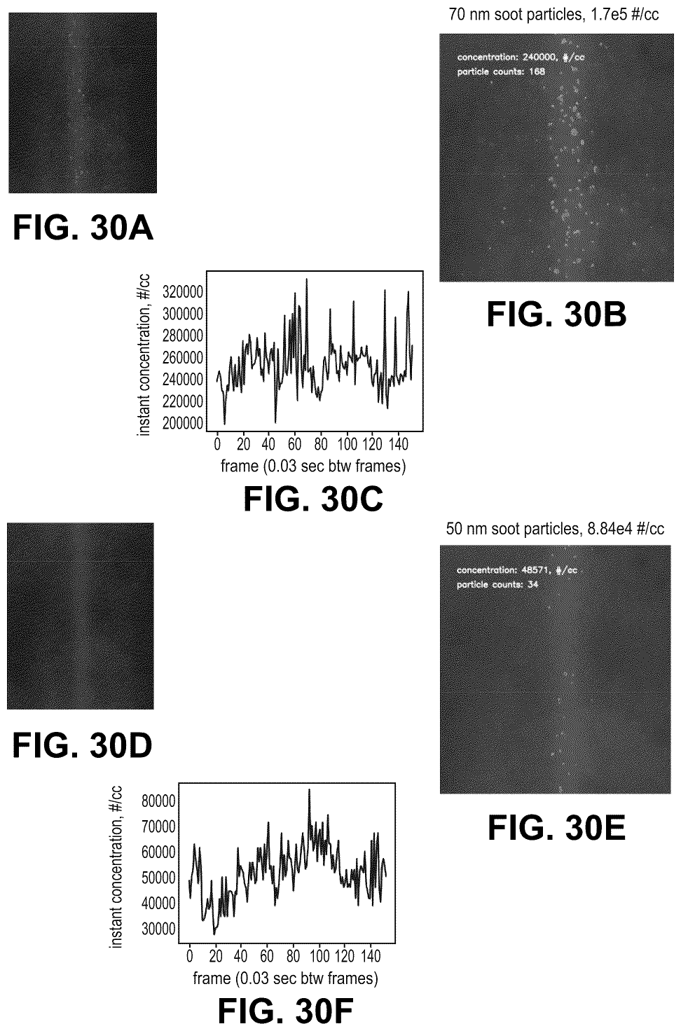

FIGS. 30A-F show an imaging process for particle recognition for soot particles with known particle concentrations. FIGS. 30A-C show images and plots for 70 nm soot particles at a concentration of 1.7×10⁵ particles per cc, and FIGS. 30D-F show images and plots for 50 nm soot particles at a concentration of 8.8×10⁴ particles per cc.

A blue laser was used to detect the particles, but the processed images can be any color. The 70 nm particles are highlighted and more visible, and for the 50 nm particles, the image processing reveals that some of the particles are difficult to see with the naked eye.

These results indicate that the cutoff for particle detection using the device of this example is roughly around 50 nm.

### Example 8

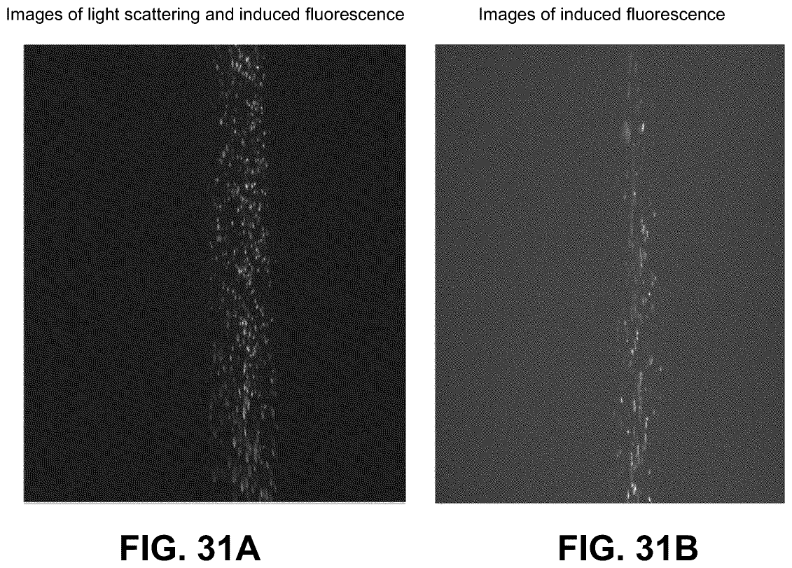

A bioaerosol detector shown in FIG. 7C above employed a blue laser with an output wavelength of 405 nm to obtain images of both light scattering and fluorescence from riboflavin particles suspended in air. An image of light scattering and fluorescence from the riboflavin particles is shown in FIG. 31A, and an image of the induced fluorescence from the riboflavin particles is shown in FIG. 31B.

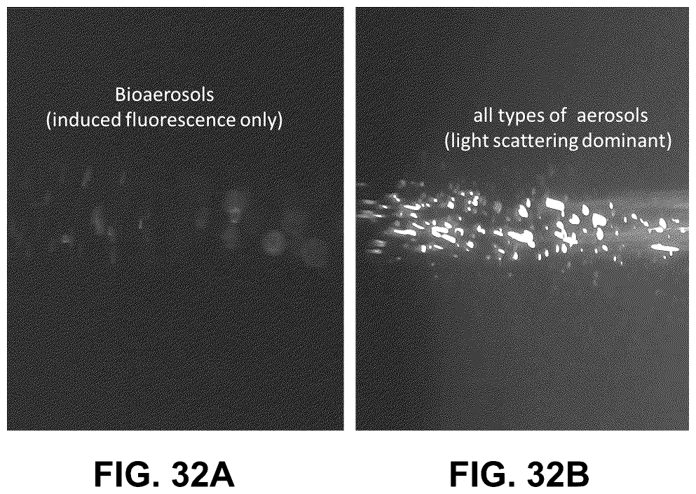

FIG. 32A shows induced fluorescence of a bioaerosol obtained with the detector of FIG. 7C, and FIG. 32B is an image of all types of aerosols in a sample, indicating that light scattering the sample was dominant.

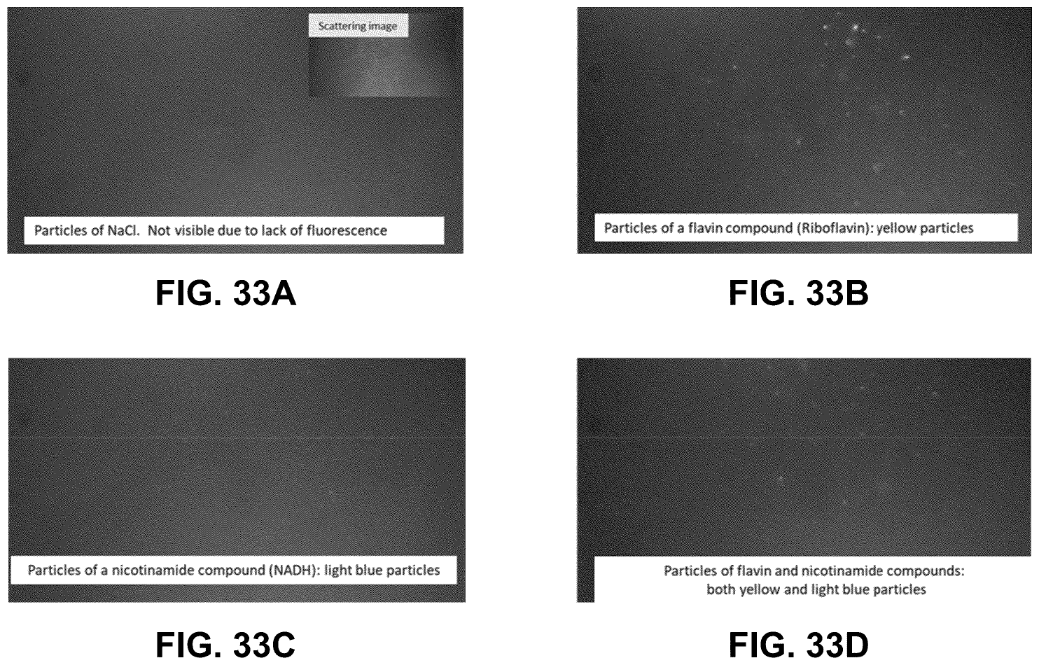

In FIGS. 33A-D, the detector of FIG. 7C utilized a UV LED with an output wavelength of 365 nm selected to induce fluorescence in airborne bioanalyte particles. FIG. 33A shows that particles of NaCl were not visible on the detector due to lack of fluorescence, while FIG. 33B shows that nicotinamide (NADH) particles fluoresced to produce an image with light blue particles. FIG. 33C shows that a flavin compound (riboflavin) produced yellow particle images, and FIG. 33D shows that a mixture of flavin and NADH particles produced an image with both yellow and blue particles.

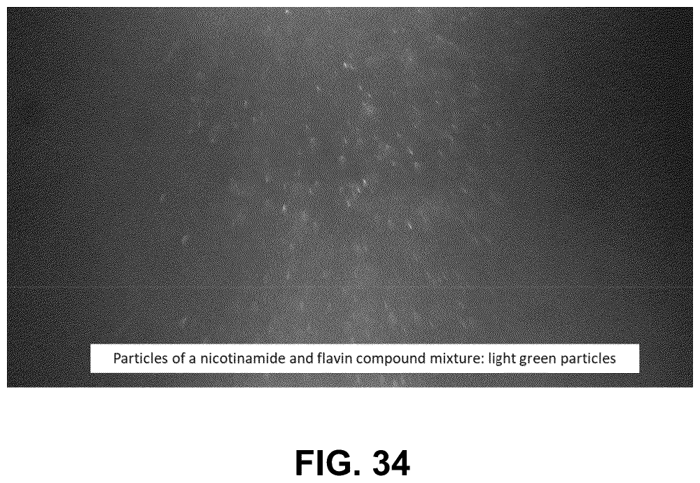

FIG. 34 also shows an image of a mixture of flavin and nicotinamide particles, which showed light green particles.

Since bacteria contain significant amounts of flavin and nicotinamide compounds, these results indicate that the small, handheld detector of FIG. 7C can be used to detect airborne bacteria.

### EMBODIMENTS

Embodiment 1. An apparatus for detecting an analyte particle, the apparatus comprising:
a sample cell configured to be loaded with a sample comprising at least one analyte particle suspended in a suspension medium;
an optical source configured to irradiate the sample cell with an optical input signal, and wherein the optical input signal is selected to produce a first light signal from the analyte particle in the sample and a second light signal from atoms or molecules in the suspension medium of the sample;
air afocal optical train configured to transmit the first light signal and the second light signal from the sample cell to an image sensor, wherein the first light signal forms an analyte image on the image sensor, and the second light signal forms a background image on the image sensor.
   Embodiment 2. The apparatus of Embodiment 1, wherein the first light signal and the second light signal each comprise a scattering light signal and a fluorescent light signal, and the fluorescent light signal in the first light signal has a wavelength that is different from a wavelength of the optical input signal and the second light signal.
   Embodiment 3. The apparatus of Embodiment 1, wherein the first light signal comprises a fluorescent light signal induced in the analyte particle by the optical input signal, and wherein the fluorescent light signal has a wavelength different from a wavelength of the optical input signal.
   Embodiment 4. The apparatus of Embodiment 1, wherein the first light signal comprises a scattering light signal and a fluorescent light signal, and the second light signal comprises a scattering light signal.
   Embodiment 5. The apparatus of any of Embodiments to 4, wherein the optical source is configured to enhance the second light signal to form a peak of a sum of the first light signal and the second light signal, and wherein the peak is above a detection limit of the image sensor.
   Embodiment 6. The apparatus of Embodiment 5, wherein the optical source is configured to cause constructive interference between the first light signal and the second light signal.
   Embodiment 7. The apparatus of any of Embodiments 1 to 6, wherein the optical input signal is collimated.
   Embodiment 8. The apparatus of any of Embodiments 1 to 7, further comprising a rotatable linear polarizer between the light source and the sample cell, wherein the rotatable linear polarizer varies an angle between a plane of linear polarization of the optical input signal and a sensing plane of the image sensor.
   Embodiment 9. The apparatus of any of Embodiments 1 to 8, further comprising an optical train between the light source and the sample cell, wherein the optical train comprises a Powell lens configured to produce an optical input signal comprising a flat substantially rectangular beam when viewed in a plane normal to a sensing plane of the image sensor.
   Embodiment 10. The apparatus of Embodiment 9, wherein the flat substantially rectangular beam has an angle β relative to a beam propagation direction of about 0° to about 75°.
   Embodiment 11. The apparatus of Embodiment 10, wherein the flat rectangular beam has a width of less than about 0.5 mm.
   Embodiment 12. The apparatus of any of Embodiments 1 to 11, wherein the image sensor is a color image sensor comprising red, green, and blue light sensing pixels, and wherein a wavelength of the optical input signal is selected to correspond to the green light sensing pixel having a highest quantum efficiency compared to the red and blue light sensing pixels.
   Embodiment 13. The apparatus of Embodiment 12, wherein the optical input signal has an output wavelength of about 532 nm.
   Embodiment 14. The apparatus of any of Embodiments 1 to 11, wherein the image sensor is a monochromatic image sensor, and wherein the wavelength of the optical input signal is about 450 nm.
   Embodiment 15. The apparatus of any of Embodiments 1 to 14, wherein the power of the optical source is selected under a darkness condition sufficient to produce an optical input signal that causes the second light signal visible by the image sensor.
   Embodiment 16. The apparatus of Embodiment 15, wherein the image sensor has a sensitivity greater than 0.01 lux with an exposure time greater than about 20 milliseconds set at full gain.
   Embodiment 17. The apparatus of any of Embodiments 1 to 16, wherein the afocal optical train has a focal length of about 5 mm to about 100 mm.
   Embodiment 18. The apparatus of Embodiment 17, wherein a diameter of a lens entrance pupil of the afocal optical train is about 2 mm to about 30 mm.
   Embodiment 19. The apparatus of any of Embodiments 1 to 18, wherein the image sensor has a sensitivity greater than about 0.05 lux.
   Embodiment 20. The apparatus of any of Embodiments 1 to 19, wherein the image sensor has a resolution greater than about 1.3 megapixels.
   Embodiment 21. The apparatus of Embodiment 20, wherein the image sensor comprises pixels of a size smaller than about 3 microns by about 3 microns.
   Embodiment 22. The apparatus of any of Embodiments 1, to 21, wherein the analyte particles in the sample are suspended in a gaseous suspension medium.
   Embodiment 23. The apparatus of any of Embodiments 1 to 21, wherein the analyte particles in the sample are suspended in a liquid suspension medium.
   Embodiment 24. The apparatus of any of Embodiments 1 to 23, further comprising an image analysis module, the image analysis module comprising a processor configured to perform at least one of the following functions: (1) display or analyze analyte particles having a dimension within a predetermined size range; (2) display or analyze analyte particles having a predetermined brightness to provide a particle concentration measurement; or (3) analyze an image of individual selected analyte particles.
   Embodiment 25. The apparatus of any of Embodiments 1 to 24, wherein the optical source is chosen from a laser, a light emitting diode (LED), and combinations thereof.
   Embodiment 26. The apparatus of Embodiment 25, wherein the optical source comprises a LED that emits an optical input signal with a wavelength of about 250 nm to about 405 nm.
   Embodiment 27. The apparatus of any of Embodiments 1 to 26, further comprising a fluorescence detector configured to analyze a color of a fluorescent light signal induced in the analyte particle by the optical input signal, wherein a wavelength of the fluorescent light signal is different from a wavelength of the optical input signal and a wavelength of the second light signal.
   Embodiment 28. A method, comprising:
loading into a sample cell a sample comprising at least one analyte suspended in a suspension medium;
irradiating the sample with an optical input signal emitted by a light source;
producing, with the optical input signal, a first light signal from the analyte particle in the sample and a second light signal from atoms or molecules in the suspension medium of the sample;
transmitting the first light signal and the second light signal through an afocal optical train to an image sensor, wherein the second light signal forms a background image on the image sensor, and the first light scattering signal forms an analyte image on the image sensor.
   Embodiment 29. The method of Embodiment 28, wherein the first light signal and the second light signal each comprise scattering light signals having a wavelength that is the same as a wavelength of the optical input signal.
   Embodiment 30. The method of Embodiment 28, wherein the first light signal comprises a fluorescent light signal induced in the analyte particle by the optical input signal, and wherein the fluorescent light signal has a wavelength different from a wavelength of the optical input signal.
   Embodiment 31. The method of Embodiment 28, wherein the first light signal comprises a scattering light signal and a fluorescent light signal, and the second light signal comprises a scattering light signal and a fluorescent light signal.
   Embodiment 32. The method of any of Embodiments 28 to 31, further comprising controlling the power of the light source to enhance the second light signal to form a peak of a sum of the first light signal and the second light signal, and wherein the peak is above a minimal detection limit of the sensor.
   Embodiment 33. The method of Embodiment 32, wherein controlling the power of the light source comprises causing constructive interference between the first light scattering signal and the second light scattering signal.
   Embodiment 34. The method of any of Embodiments 28 to 33, wherein the optical input signal is collimated.
   Embodiment 35. The method of any of Embodiments 28 to 34, wherein the optical input signal has a conical profile.
   Embodiment 36. The method of any of Embodiments 28 to 35, wherein the light source is chosen from a laser, a light emitting diode (LED), and combinations thereof.
   Embodiment 37. The method of any of Embodiments 28 to 36, wherein the image sensor is a color image sensor comprising red, green, and blue light sensing pixels, and wherein a wavelength of the optical input signal is selected to correspond to the green light sensing pixel having a highest quantum efficiency compared to the red and blue light sensing pixels.
   Embodiment 38. The method of Embodiment 37, wherein the optical input signal has an output wavelength of about 532 nm.
   Embodiment 39. The method of any of Embodiments 28 to 36, wherein the image sensor is a monochromatic image sensor, and the light source comprises a laser that emits an optical input signal with a wavelength of about 450 nm.
   Embodiment 40. The method of Embodiment 37, wherein the light source comprises a LED or a laser that emits an optical input signal with a wavelength of about 250 nm to about 405 nm.
   Embodiment 41. The method of any of Embodiments 28 to 40, further comprising rotating a polarizer between the light source and the sample cell to vary an angle between a plane of polarization of the optical input signal and a sensing plane of the image sensor.
   Embodiment 42. The method of Embodiment 41, wherein the polarizer is chosen from linear polarizers, circular polarizers, and combinations thereof.
   Embodiment 43. The method of Embodiment 42, wherein rotating the polarizer comprises rotating the polarizer at a rate of about 10° per minute.
   Embodiment 44. The method of any of Embodiments 28 to 43, further comprising inserting an optical train between the light source and the sample cell, wherein the optical train comprises a Powell lens configured to produce an optical input signal comprising a flat substantially rectangular beam when viewed in a plane normal to a sensing plane of the image sensor.
   Embodiment 45. The method of Embodiment 44, wherein the flat substantially rectangular beam has an angle β relative to a beam propagation direction of about 0° to about 75°.
   Embodiment 46. The method of Embodiment 45, wherein the flat rectangular beam has a width of less than about 0.5 mm.
   Embodiment 47. The method of any of Embodiments 28 to 46, comprising selecting the power of the laser under a darkness condition sufficient to produce an optical input signal greater than a power that causes the second light signal to be visible by the image sensor.
   Embodiment 48. The method of Embodiment 47, wherein the image sensor has a sensitivity greater than 0.01 lux with an exposure time greater than about 50 milliseconds set at full gain.
   Embodiment 49. The method of any of Embodiments 28 to 48, wherein the afocal optical train has a focal length of about 5 mm to about 100 mm.
   Embodiment 50. The method of Embodiment 49, wherein a diameter of a lens entrance pupil of the afocal optical train is about 2 mm to about 30 mm.
   Embodiment 51. The method of any of Embodiments 28 to 50, wherein the image sensor has a sensitivity greater than about 0.05 lux.
   Embodiment 52. The method of any of Embodiments 28 to 51, wherein the image sensor has a resolution greater than about 1.3 megapixels.
   Embodiment 53. The method of Embodiment 52, wherein the image sensor comprises pixels smaller than about 3 microns by about 3 microns.
   Embodiment 54. The method of any of Embodiments 28 to 53, wherein the analyte particles in the sample are suspended in a gaseous suspension medium.
   Embodiment 55. The method of any of Embodiments 28 to 54, wherein the analyte particles in the sample are suspended in a liquid suspension medium.
   Embodiment 56. The method of any of Embodiments 28 to 55, further comprising analyzing, with an image analysis module interfaced with the image sensor, analyte particles having a dimension within a predetermined size range.
   Embodiment 59. The method of any of Embodiments 28 to 58, further comprising analyzing, with an image analysis module interfaced with the image sensor, analyte particles having a predetermined brightness to provide a particle concentration measurement.
   Embodiment 60. The method of any of Embodiments 28 to 59, further comprising analyzing, with an image analysis module interfaced with the image sensor, an image of individual selected analyte particles.
   Embodiment 61. The method of any of Embodiments 28 to 60, further comprising analyzing, with a fluorescence detector, a color of a fluorescent light signal induced by the optical input signal.
   Embodiment 62. A detector for analyzing a sample comprising an analyte particle suspended in a suspension medium, the detector comprising:
a particle viewing module comprising a particle viewing chamber configured to retain the sample;
an image sensing module connected to the particle viewing module, wherein the image sensing module comprises an afocal first lens system interfaced with the particle viewing chamber and an image sensing array configured to receive an optical input from the afocal first lens system;
a laser module comprising at least one laser diode that emits a laser beam with a wavelength detectable by the image sensing array, and a second lens system configured to adjust a shape of the laser beam, wherein the laser beam irradiates the particle viewing chamber to produce a first light signal from the analyte particle in the sample, and a second light signal from atoms or molecules in the suspension medium in the sample; and
wherein the first light signal and the second light signal are transmitted through the afocal first lens system to form., on the image sensing array, a background image derived from the second light scattering signal, and an image of the analyte particle derived from first light scattering signal.
   Embodiment 63. The detector of Embodiment 62, wherein the first light signal and the second light signal each comprise a scattering light signal and a fluorescent light signal, and the fluorescent light signal in the first light signal has a wavelength that is different from a wavelength of the optical input signal and the second light signal.
   Embodiment 64. The detector of Embodiment 62, wherein the first light signal comprises a fluorescent light signal induced in the analyte particle by the optical input signal, and wherein the fluorescent light signal has a wavelength different from a wavelength of the optical input signal.
   Embodiment 65. The detector of Embodiment 62, wherein the first light signal comprises a scattering light signal having the same wavelength as the optical input signal and a fluorescent light signal with a wavelength different from the wavelength of the optical input signal, and the second light signal comprises a scattering light signal having the same wavelength as the optical input signal.
   Embodiment 66. The method of any of Embodiments 62 to 65, wherein the light source has a power sufficient to enhance the second light signal to form a peak of a sum of the first light signal and the second light signal, and wherein the peak is above a minimal detection limit of the image sensing array.
   Embodiment 67. The method of Embodiment 66, wherein the light source has a power sufficient to form constructive interference between the first light signal and the second light signal.
   Embodiment 68. The particle detector of any of Embodiments 62 to 67, wherein the particle viewing chamber comprises a sample inlet and a sample outlet, and the sample enters in the particle viewing chamber via the sample inlet and exits the particle viewing chamber via the sample outlet.
   Embodiment 69. The particle detector of any of Embodiments 62 to 68, wherein the particle viewing chamber comprises at least one structure configured to reduce reflection of the laser beam for better darkness in the particle viewing chamber.
   Embodiment 70. The particle detector of any of Embodiments 62 to 69, wherein the particle viewing chamber comprises at least one light trap.
   Embodiment 71. The particle detector of Embodiment 70, wherein the laser module is on a first end of the particle viewing chamber, and the light trap is on a second end of the particle viewing chamber opposite the first end thereof.
   Embodiment 72. The particle detector of any of Embodiments 62 to 71, wherein the image sensing module is between the first end of the particle viewing chamber and the second end of the particle viewing chamber.
   Embodiment 73. The particle detector of any of Embodiments 62 to 72, wherein the image sensing array is in a plane substantially normal to a direction of propagation of the laser beam.
   Embodiment 74. The particle detector of any of Embodiments 62 to 73, wherein the laser beam is collimated or slightly focused.
   Embodiment 75. The particle detector of any of Embodiments 62 to 74, wherein the laser beam has a conical profile.
   Embodiment 76. The particle detector of any of Embodiments 62 to 75, wherein the analyte particles are suspended in a gaseous suspension medium.
   Embodiment 77. The particle detector of any of Embodiments 62 to 76, wherein the analyte particles are suspended in a liquid suspension medium.
   Embodiment 78. The particle detector of any of Embodiments 62 to 77, wherein the image sensing array comprises at least 2 megapixels,
   Embodiment 79. A detection system for analyzing a sample comprising an anal particle suspended in a liquid medium, the detection system comprising:
an image sensing module comprising an afocal first lens system and an image sensing array configured to receive an optical input from the afocal first lens system;
a laser module comprising at least one laser diode that emits a laser beam with a wavelength detectable by the image sensing army, and a second lens system configured to adjust a shape of the laser beam,
a container containing the sample, wherein a least a portion of a wall of the container is transparent at the wavelength of the laser beam;
wherein the laser beam irradiates the sample in the container to produce a first light signal from the analyte particle in the sample and a second light signal from atoms or molecules in the liquid medium in the sample; and
wherein the first light signal and the second light signal are transmitted through the afocal first lens system to form a background image on the image sensing array derived from the second light signal, and an analyte particle image on the image sensing array derived from first light signal.
   Embodiment 80. The detection system of Embodiment 79, wherein the second lens system comprises at least one polarizer.
   Embodiment 81. The detection system of Embodiment 80, wherein the polarizer is a rotatable linear or circular polarizer configured to adjust an intensity of the laser beam.
   Embodiment 82. The detection system of Embodiment 81, wherein the rotatable linear or circular polarizer is rotatable at up to about 10° per second.
   Embodiment 83. The detection system of any of Embodiments 79 to 82, wherein the second lens system comprises a Powell lens configured to produce an optical input signal comprising a flat substantially rectangular beam when viewed in a plane normal to a sensing plane of the image sensor.
   Embodiment 84. The detection system of any of Embodiments 79 to 83, further comprising at least one of a beam stopper or a beam intensity sensor between the second lens system and the first lens system, wherein the beam stopper and the beam intensity sensor are configured to detect an optical signal that has traversed the particle container.
   Embodiment 85. The detection system of any of Embodiments 79 to 84, wherein the first lens system comprises a telephoto lens.
   Embodiment 86. The detection system of any of Embodiments 79 to 85, wherein the first lens system comprises an iris.
   Embodiment 87. The detection system of any of Embodiments 79 to 86, wherein the first lens system comprises an image sensor lens.
   Embodiment 88. The detection system of Embodiment 87, wherein the image sensor lens comprises a lens attached to the image sensing array.
   Embodiment 89. The detection system of any of Embodiments 79 to 88, wherein the image sensing array comprises at least 1.3 megapixels.
   Embodiment 90. The detection system of Embodiments 79 to 89, wherein the image sensing array comprises pixels smaller than about 3 microns×3 microns.
   Embodiment 91. The detection system of any of Embodiments 79 to 90, wherein the image sensing array has a sensitivity higher than about 0.05 lux.
   Embodiment 92. The detection system of any of Embodiments 79 to 91, wherein the container comprises a polymeric water bottle.
   Embodiment 93. The detection system of any of Embodiments 79 to 92, wherein the container comprises a cuvette.
   Embodiment 94. The detection system of any of Embodiments 79 to 93, an image analysis module interfaced with the image sensing array, wherein the image analysis module detects analyte particles having a dimension within a predetermined size range.
   Embodiment 95. The detection system of any of Embodiments 79 to 94, further comprising an image analysis module interfaced with the image sensing array, wherein the image analysis module detects analyte particles having a predetermined brightness to measure an analyte particle concentration measurement in the sample.
   Embodiment 96. The detection system of any of Embodiments 79 to 95, further comprising an image analysis module interfaced with the image sensing array; wherein the image analysis module outputs an image of individual selected analyte particles.
   Embodiment 97. A method for analyzing a sample comprising an analyte particle suspended in a liquid medium, the method comprising:
placing a container containing the sample in an analyte detection system comprising:
   an image sensing module comprising an afocal first lens system and an image sensing array configured to receive an optical input from the afocal first lens system; and
   a laser module comprising at least one laser diode that emits a laser beam with a wavelength detectable by the image sensing array and transmissible through a wall of the container, and a second lens system configured to adjust a shape of the laser beam,
irradiating the sample in the container with the laser to produce a first light signal from the analyte particle in the sample and a second light signal from atoms or molecules in the liquid medium in the sample; and
transmitting the first light signal and the second light signal through the afocal first lens system to form a background image on the image sensing array derived from the second light signal, and an analyte image on the image sensing array derived from first light signal.
   Embodiment 98. The method of Embodiment 97, wherein the sample comprises a vaccine composition, and wherein the sample is contained within a sealed vial.
   Embodiment 99. The method of Embodiment 97, wherein the analyte particles comprise solids in a liquid medium comprising gasoline or diesel fuel.
   Embodiment 100. The method of Embodiment 97. wherein the container is a clean room liquid container.
   Embodiment 101. The method of any of Embodiments 97 to 100, wherein the analyte particles have a detectable dimension of about 5 nm to about 300 nm.
   Embodiment 102. A detection system for analysis of a sample comprising a biological analyte particle suspended in air, the detection system comprising:
an image sensing module comprising an afocal first lens system and a color image sensing array configured to receive an optical input from the afocal first lens system; wherein the color sensing array comprises red, blue and green color sensing pixels;
an optical module comprising at least one light emitting diode (LED) or a laser that emits an optical signal comprising a wavelength of less than about 405 nm, and a second lens system configured to adjust a shape of a beam emitted by the LED;
an air permeable sample container containing the sample; and
wherein the beam emitted by the LED or laser irradiates the sample to induce a fluorescent light signal from the biological analyte particle; and
wherein the fluorescent light signal is transmitted through the afocal first lens system to form an analyte particle image on the image sensing array.
   Embodiment 103. The detection system of Embodiment 102, further comprising an image analysis module interfaced with the image sensing array, wherein the image analysis module is configured to detect a fluorescent signature of a selected biological analyte particle.
   Embodiment 104. The detection system of Embodiment 103, wherein the image analysis module is configured to output a number of biological analyte particles with the fluorescent signature.
   Embodiment 105. The detection system of Embodiment 102, further comprising an image analysis module interfaced with the image sensing array; wherein the image analysis module is configured to detect biological analyte particles having a dimension within a predetermined particle size range.
   Embodiment 106. The detection system of any of Embodiments 102 to 105, wherein the image analysis module is configured to output a number, or number concentration, of biological analyte particles within the predetermined particle size range.
   Embodiment 107. The detection system of any of Embodiments 102 to 106, further comprising an image analysis module interfaced with the image sensing array, wherein the image analysis module is configured to produce an image of a selected biological analyte particle.
   Embodiment 108. The detection system of any of Embodiments 102 to 107, wherein the second lens system further comprises an optical filter selected to remove a scattering light signal scattered from the analyte particle that has a same wavelength as a wavelength of the optical input signal.
   Embodiment 109, The detection system of any of Embodiments 102 to 108, wherein the first lens system further comprises a filter to remove noise having wavelengths outside a selected wavelength range of the input optical signal.
   Embodiment 110. A method for detecting a biological analyte particle in an air sample, the method comprising:
passing the sample through a sample module;
irradiating the sample in the sample module with an optical signal from at least one light emitting diode (LED) or laser, wherein the optical signal has a wavelength of less than about 405 nm, and wherein the optical signal induces a fluorescent light signal from the biological analyte particle;
processing the fluorescent light signal with a color image sensing module, wherein and the fluorescent light signal forms an image on the image sensing array; and
analyzing the image to detect a fluorescent signature of a selected biological analyte particle in the sample.
   Embodiment 111. The method of Embodiment 110, wherein the analyzing comprises identifying the color, or wavelength, of the fluorescent light signal with the color image sensor, wherein the color image sensor comprises red, green and blue color sensing pixels.
   Embodiment 112. The method of any of Embodiments 110 to 111, wherein the analyzing step is performed in an image analysis module configured to output a number of biological analyte particles with the fluorescent signature,
   Embodiment 113. The method of any of Embodiments 110 to 112, further comprising analyzing the image to detect biological analyte particles having a dimension within a predetermined particle size range.
   Embodiment 114. The method of any of Embodiments 110 to 113, wherein the analyzing step is performed by an image analysis module configured to output a number of biological analyte particles within the predetermined particle size range.
   Embodiment 115. The method of any of Embodiments 110 to 114, further comprising analyzing the fluorescent optical signal with an image analysis module interfaced with the image sensing array, wherein the image analysis module is configured to detect a biological analyte.
   Embodiment 116, The method of any of Embodiments 110 to 115, further comprising analyzing the fluorescent light signal with an image analysis module interfaced with the image sensing array, wherein the image analysis module is configured to produce an image of a selected biological analyte particle.
   Embodiment 117. A bioaerosol detector, comprising:
an air permeable dark space configured to sample ambient air to detect a biological analyte particle suspended therein;
an optical module comprising at least one light emitting diode (LED) or laser that emits an optical signal comprising a wavelength of less than about 405 nm, wherein the optical signal irradiates the sample in the dark space;
an image sensing module comprising an image sensing array configured to receive an optical input from the dark space; wherein the image sensing module comprises a color image sensing module;
wherein the optical signal induces a fluorescent light signal from the biological analyte particle in the sample, and wherein fluorescent light signal forms a biological analyte particle image on the image sensing array.
   Embodiment 118. The detector of Embodiment 117, further comprising an image analysis module interfaced with the image sensing array, wherein the image analysis module is configured to detect a fluorescent signature of a selected biological analyte particle.
   Embodiment 119, The detector of Embodiment 118, wherein the image analysis module is configured to, continuously or periodically, output a number and a color of biological analyte particles with the fluorescent signature.
   Embodiment 120. The detector of any of Embodiments 117 to 119, wherein the detector has a weight of less than about 50 grams.
   Embodiment 121. The detector of any of Embodiments 117 to 120, wherein the detector consumes less than about 5W of total power.
   Embodiment 122, The detector of any of Embodiments 117 to 121, wherein the detector is attachable to clothing or a surface.
   Embodiment 123. The detector of any of Embodiments 117 to 122, wherein further comprising an alarm configured to provide an audible alert when a selected biological analyte particle is detected, or when a predetermined number of a selected biological analyte particle is detected.
   Embodiment 124, The detector of any of Embodiments 117 to 123, wherein the detector is incorporated into a network comprising a plurality of detectors,
   Embodiment 125. The detector of Embodiment 124, wherein each of the detectors in the network of detectors are deployed at different locations.

Various examples have been described, These and other examples are within the scope of the following claims.

1. An apparatus for detecting an analyte particle, the apparatus comprising:
a sample cell configured to be loaded with a sample comprising at least one analyte particle suspended in a suspension medium;
an optical source configured to irradiate the sample cell with an optical input signal, and wherein the optical input signal is selected to produce a first light signal from the analyte particle in the sample and a second light signal from atoms or molecules in the suspension medium of the sample; and
an afocal optical train configured to transmit the first light signal and the second light signal from the sample cell to an image sensor, wherein the first light signal forms an analyte image on the image sensor, and the second light signal forms a background image on the image sensor.

2. The apparatus of claim 1, wherein the first light signal and the second light signal each comprise a scattering light signal and a fluorescent light signal, and the fluorescent light signal in the first light signal has a wavelength that is different from a wavelength of the optical input signal and the second light signal.

3. The apparatus of claim 1, wherein the first light signal comprises a fluorescent light signal induced in the analyte particle by the optical input signal, and wherein the fluorescent light signal has a wavelength different from a wavelength of the optical input signal.

4. The apparatus of claim 1, wherein the first light signal comprises a scattering light signal and a fluorescent light signal, and the second light signal comprises a scattering light signal.

5. The apparatus of claim 1, wherein the image sensor is a color image sensor comprising red, green, and blue light sensing pixels, and wherein a wavelength of the optical input signal is selected to correspond to the green light sensing pixel having a highest quantum efficiency compared to the red and blue light sensing pixels.

6. The apparatus of claim 1, wherein a power of the optical source is selected under a darkness condition sufficient to produce an optical input signal that causes the second light signal visible by the image sensor.

7. The apparatus of claim 1, further comprising an image analysis module, the image analysis module comprising a processor configured to perform at least one of the following functions: (1) display or analyze analyte particles having a dimension within a predetermined size range; (2) display or analyze analyte particles having a predetermined brightness to provide a particle concentration measurement; or (3) analyze an image of individual selected analyte particles.

8. The apparatus of 1, further comprising a fluorescence detector configured to analyze a color of a fluorescent light signal induced in the analyte particle by the optical input signal, wherein a wavelength of the fluorescent light signal is different from a wavelength of the optical input signal and a wavelength of the second light signal.

9. A method, comprising:
loading into a sample cell a sample comprising at least one analyte particle suspended in a suspension medium;
irradiating the sample with an optical input signal emitted by a light source;
producing, with the optical input signal, a first light signal from the analyte particle in the sample and a second light signal from atoms or molecules in the suspension medium of the sample; and
transmitting the first light signal and the second light signal through an afocal optical train to an image sensor, wherein the second light signal forms a background image on the image sensor, and the first light scattering signal forms an analyte image on the image sensor.

10. The method of claim 9, wherein the first light signal and the second light signal each comprise scattering light signals having a wavelength that is the same as a wavelength of the optical input signal.

11. The method of claim 9, wherein the first light signal comprises a fluorescent light signal induced in the analyte particle by the optical input signal, and wherein the fluorescent light signal has a wavelength different from a wavelength of the optical input signal.

12. The method of claim 9, wherein the first light signal comprises a scattering light signal and a fluorescent light signal, and the second light signal comprises a scattering light signal and a fluorescent light signal.

13. The method of claim 9, wherein the image sensor is a color image sensor comprising red, green, and blue light sensing pixels, and wherein a wavelength of the optical input signal is selected to correspond to the green light sensing pixel having a highest quantum efficiency compared to the red and blue light sensing pixels.

14. The method of claim 9, comprising selecting a power of the light source under a darkness condition sufficient to produce an optical input signal greater than a power that causes the second light signal to be visible by the image sensor.

15. The method of claim 9, further comprising analyzing, with an image analysis module interfaced with the image sensor, analyte particles having a dimension within a predetermined size range.

16. The method of claim 9, further comprising analyzing, with an image analysis module interfaced with the image sensor, analyte particles having a predetermined brightness to provide a particle concentration measurement.

17. The method of claim 9, further comprising analyzing, with an image analysis module interfaced with the image sensor, an image of individual selected analyte particles.

18. The method of claim 9, further comprising analyzing, with a fluorescence detector, a color of a fluorescent light signal induced by the optical input signal.

19. A method for detecting a biological analyte particle in an air sample, the method comprising:
passing the air sample through a sample module;
irradiating the air sample in the sample module with an optical signal from at least one light emitting diode (LED) or laser, wherein the optical signal has a wavelength of less than about 405 nm, and wherein the optical signal induces a fluorescent light signal from the biological analyte particle;
processing the fluorescent light signal with a color image sensing module, wherein and the fluorescent light signal forms an image on the image sensing array; and
analyzing the image to detect a fluorescent signature of a selected biological analyte particle in the sample.

20. The method of claim 19, wherein the analyzing comprises identifying the color, or wavelength, of the fluorescent light signal with the color image sensor, wherein the color image sensor comprises red, green and blue color sensing pixels.

21.-25 (canceled)
